(19) United States
(12) Patent Application Publication
(10) Pub. No.: US 2026/0118958 A1
(43) Pub. Date: Apr. 30, 2026

(54) MOUNTING MEMBER AND HAPTIC FORCE FEEDBACK DEVICE

(71) Applicant: Sony Interactive Entertainment Inc., Tokyo (JP)

(72) Inventors: Yuko Hirowatari, Tokyo (JP); Toru KURONUMA, Kanagawa (JP); Akira Homma, Tochigi (JP)

(21) Appl. No.: 19/433,595

(22) Filed: Dec. 26, 2025

Related U.S. Application Data
(63) Continuation of application No. PCT/JP2023/024682, filed on Jul. 3, 2023.

(51) Int. Cl. G06F 3/01

(52) U.S. Cl. CPC G06F 3/014

(57) ABSTRACT

A mounting member (6A) is used in a haptic force feedback device (2) that provides haptic force feedback to a hand, and mounted on the hand, and the mounting member (6A) includes: a base part (61) disposed in contact with a back of the hand; a mounting part (63) provided on one end portion of the base part (61) and mounted on a wrist of the hand; and a ring-shaped part (62) provided on the other end portion of the base part (61), into which a target finger among fingers of the hand is inserted, wherein the ring-shaped part (62) is disposed at a base of the target finger inserted into the ring-shaped part (62) to make contact with a ventral portion of the target finger.

### CROSS-REFERENCE TO RELATED APPLICATIONS

This application is a Bypass Continuation of International Application No. PCT/JP2023/024682, having an International Filing Date of Jul. 3, 2023. This disclosure of the prior application is considered part of (and is incorporated by reference in) the disclosure of this application.

### TECHNICAL FIELD

The present invention relates to a mounting member and a haptic force feedback device.

### BACKGROUND TECHNOLOGY

In the related art, there is known a hand motion capture device that can give a user the sensation of gripping an object by applying a reaction force to a gripping motion (for example, see Patent Document 1).

The hand motion capture device described in Patent Document 1 is mounted on a hand of a user when in use. The hand motion capture device includes a base, a fixing device, a plurality of connection rod structures, a first haptic force drive device, a second haptic force drive device, a third haptic force drive device, and a control device.

The base is disposed on a back of a hand by the fixing device and fixed by the fixing device. The plurality of connection rod structures and the control device are provided on the base.

The plurality of connection rod structures include rods, hinges, bearings, etc., and are provided corresponding to fingers of a hand.

The fixing device includes a palm fixing element and a finger fixing element. Examples of the structure of the palm fixing element may include a strap structure, a glove structure, or a bracelet structure mounted on the palm, and the palm fixing element fixes the base to which one end of the connection rod structure is connected to the palm. Examples of the structure of the finger fixing element include a necktie structure or a finger cot structure into which a fingertip can be inserted, and the other end of the connection rod structure is connected to the finger fixing element.

The first haptic force drive device is connected between the base and the connection rod structure to detect a rotation angle of the connection rod structure with respect to the base. The second haptic force drive device and the third haptic force drive device are disposed at the joints of the connection rod structure to detect a rotation angle of the corresponding connection rod.

When a control signal is input from the outside, the control device causes the first haptic force drive device and the second haptic force drive device to generate force feedback.

### Citation List

### Patent Document

[Patent Document 1] International Publication No. 2020/088015

### SUMMARY OF INVENTION

### Problem to be Solved by Invention

In the hand motion capture device described in Patent Document 1, since the palm fixing element has a band-like configuration that is wound around the palm and the back of the hand, the base tends to lift away from the back of the hand. In particular, the bases of the fingers tend to be separated from the base, so that the hand motion capture device is unstable for the hand.

Therefore, there has been a demand for a configuration that can enhance the wearing comfort on the body.

### Means to Solve the Problem

A mounting member according to a first aspect of the present invention, which is a mounting member used in a haptic force feedback device that provides haptic force feedback to a hand, and mounted on the hand, comprises: a base part disposed in contact with a back of the hand; a mounting part provided on one end portion of the base part and mounted on a wrist of the hand; and a ring-shaped part provided on the other end portion of the base part, into which a target finger among fingers of the hand is inserted, wherein the ring-shaped part is disposed at a base of the target finger inserted into the ring-shaped part to make contact with a ventral portion of the target finger.

A haptic force feedback device according to a second aspect of the present invention comprises: the mounting member according to the first aspect; a pressing part configured to press a ventrum of a first finger of the hand; a vibration generation part configured to apply vibration to the first finger; and a bending restriction part extending from the base part along the first finger and configured to restrict bending of the first finger.

### BRIEF DESCRIPTION OF THE DRAWINGS

FIG. 1 is a schematic view showing a schematic configuration of a haptic force feedback system according to a first embodiment.

FIG. 2 is a plan view showing a haptic force feedback device according to the first embodiment.

FIG. 3 is a perspective view showing the haptic force feedback device according to the first embodiment.

FIG. 4 is a perspective view showing a pressing part and a vibration generation part according to the first embodiment.

FIG. 5 is a perspective view showing the pressing part and the vibration generation part according to the first embodiment.

FIG. 6 is a cross-sectional view showing the pressing part and the vibration generation part according to the first embodiment.

FIG. 7 is a plan view showing a bending restriction part for an index finger according to the first embodiment.

FIG. 8 is a side view showing the bending restriction part for an index finger according to the first embodiment.

FIG. 9 is an enlarged perspective view showing a portion of the bending restriction part for an index finger according to the first embodiment.

FIG. 10 is a perspective view showing a mounting member according to the first embodiment.

FIG. 11 is a perspective view showing the mounting member according to the first embodiment.

FIG. 12 is a view showing a cushioning material according to the first embodiment.

FIG. 13 is a side view showing the haptic force feedback device according to the first embodiment when the index finger is bent.

FIG. 14 is a perspective view showing a mounting member of a haptic force feedback device included in a haptic force feedback system according to a second embodiment.

FIG. 15 is a perspective view showing a mounting member of a haptic force feedback device included in a haptic force feedback system according to a third embodiment.

FIG. 16 is a perspective view showing a mounting member of a haptic force feedback device included in a haptic force feedback system according to a fourth embodiment.

### DESCRIPTION OF THE EMBODIMENTS

### First Embodiment

Hereinafter, a first embodiment of the present invention will be described with reference to the drawings.

### Schematic Configuration of Haptic Force Feedback System

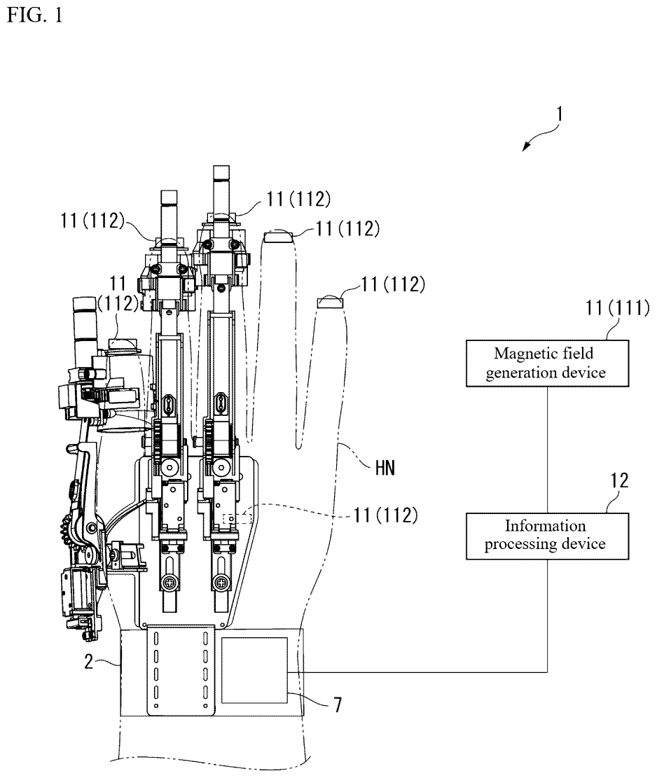

FIG. 1 is a schematic view showing a schematic configuration of a haptic force feedback system 1 according to the present embodiment.

As shown in FIG. 1, the haptic force feedback system 1 according to the present embodiment includes a detection device 11, an information processing device 12, and a haptic force feedback device 2. The haptic force feedback system 1 controls an operation of the haptic force feedback device 2 in accordance with the movement of a hand of a user, which is calculated by the detection device 11 and the information processing device 12, thereby applying a haptic force to the hand of the user wearing the haptic force feedback device 2.

Hereinafter, the configuration of the haptic force feedback system 1 will be described in detail.

In the following description, the hand of the user on which the haptic force feedback device 2 is mounted will be referred to as a target hand HN.

### Configuration of Detection Device

The detection device 11 functions as a posture calculation device that calculates a posture of the target hand HN together with the information processing device 12. In the present embodiment, the detection device 11 includes a magnetic field generation device 111 and a magnetic sensor 112.

The magnetic field generation device 111 generates a magnetic field around the target hand HN.

The magnetic sensor 112 is attached to the target hand HN. For example, the magnetic sensor 112 is provided on a tip end part of each finger of the target hand HN, on the back of the target hand HN, and on the palm of the target hand HN. The magnetic sensor 112 is a sensor that has a resistance value changed depending on the strength and direction of a magnetic field generated by the magnetic field generation device 111, and outputs the detected strength and direction of the magnetic field to the information processing device 12.

The detection device 11 may include a camera that captures an image of the target hand HN, and may calculate the posture of the target hand HN based on the image captured by the camera. In this case, the detection device 11 functions as the posture calculation device, and transmits information indicating the posture of the target hand HN to the information processing device 12.

### Schematic Configuration of Information Processing Device

The information processing device 12 calculates positions of the fingers, the back, and the palm of the target hand HN based on detection results of each magnetic sensor 112 of the detection device 11 to calculate the posture of the target hand HN.

The information processing device 12 controls the operation of the haptic force feedback device 2 mounted on the target hand HN based on the calculated posture of the target hand HN. Specifically, the information processing device 12 transmits the control signal to the haptic force feedback device 2 to operate the haptic force feedback device 2.

### Configuration of Haptic Force Feedback Device

The haptic force feedback device 2 is mounted on the target hand HN of the user. More specifically, the haptic force feedback device 2 is mounted on the target hand HN so as to connect the back, the fingers, and the wrist of the target hand HN to each other on an outer side of the target hand HN. For example, the haptic force feedback device 2 applies a reaction force to a gripping motion of the target hand HN based on the control signal input from the information processing device 12, thereby giving the target hand HN the sensation of gripping a virtual object.

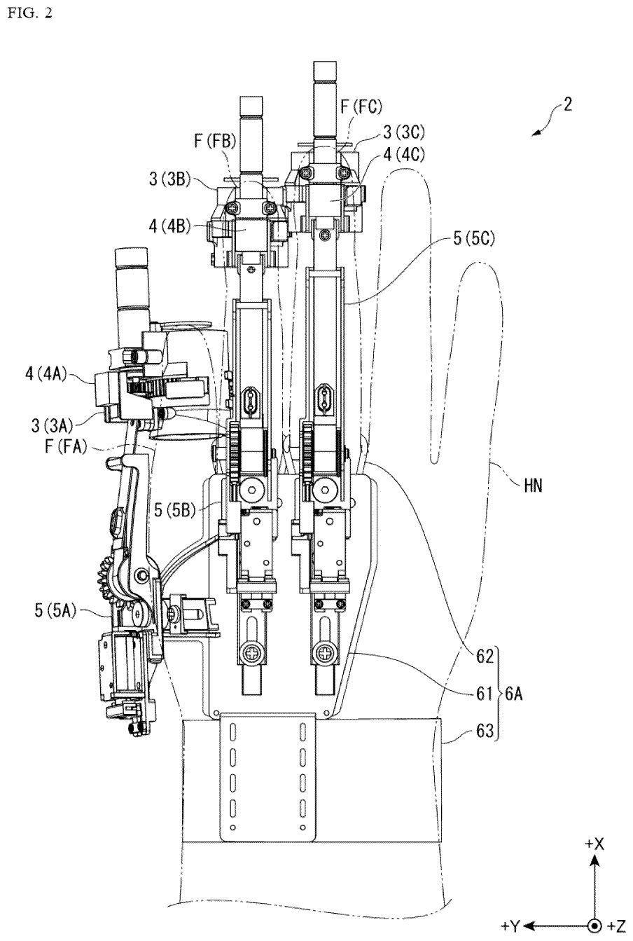

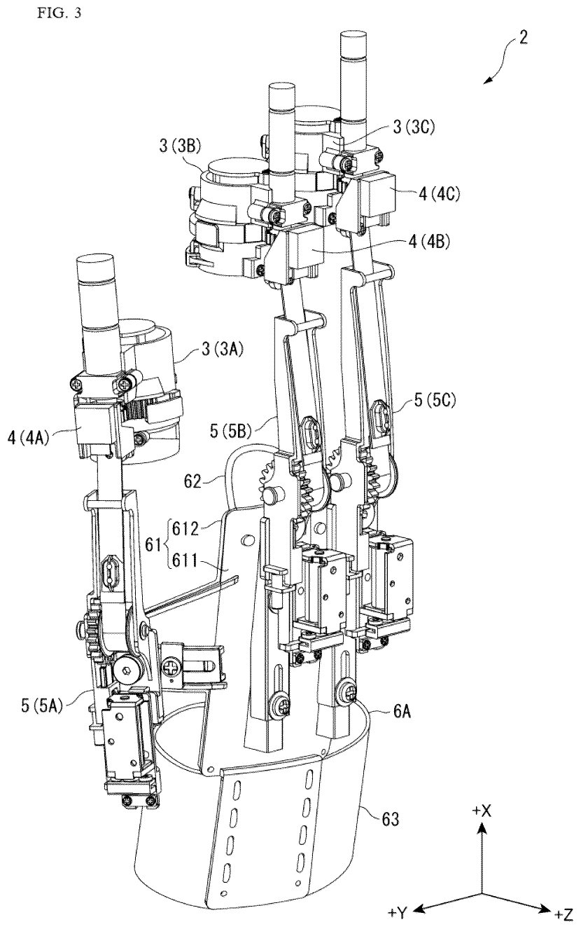

FIG. 2 is a plan view showing the haptic force feedback device 2 mounted on the target hand HN, and FIG. 3 is a perspective view showing the haptic force feedback device 2. In the drawings after FIG. 2, wiring that electrically connects the pressing part 3, the vibration generation part 4, the bending restriction part 5, and the control part 7 to each other is not shown.

The haptic force feedback device 2 includes a plurality of pressing parts 3, a plurality of vibration generation parts 4, a plurality of bending restriction parts 5, and a mounting member 6A as shown in FIGS. 2 and 3, and includes the control part 7 as shown in FIG. 1. The pressing part 3, the vibration generation part 4, and the bending restriction part 5 are provided corresponding to the fingers of the target hand HN. Among the fingers of the target hand HN, a finger on which the pressing part 3, the vibration generation part 4, and the bending restriction part 5 are provided is referred to as a target finger F.

In the following description, three directions mutually orthogonal to each other are referred to as a +X direction, a +Y direction, and a +Z direction. The direction opposite to the +X direction is referred to as a −X direction, the direction opposite to the +Y direction is referred to as a −Y direction, and the direction opposite to the +Z direction is referred to as a −Z direction. The axis along the +X direction is referred to as an X-axis, the axis along the +Y direction is referred to as a Y-axis, and the axis along the +Z direction is referred to as a Z-axis.

### Configuration of Pressing Part

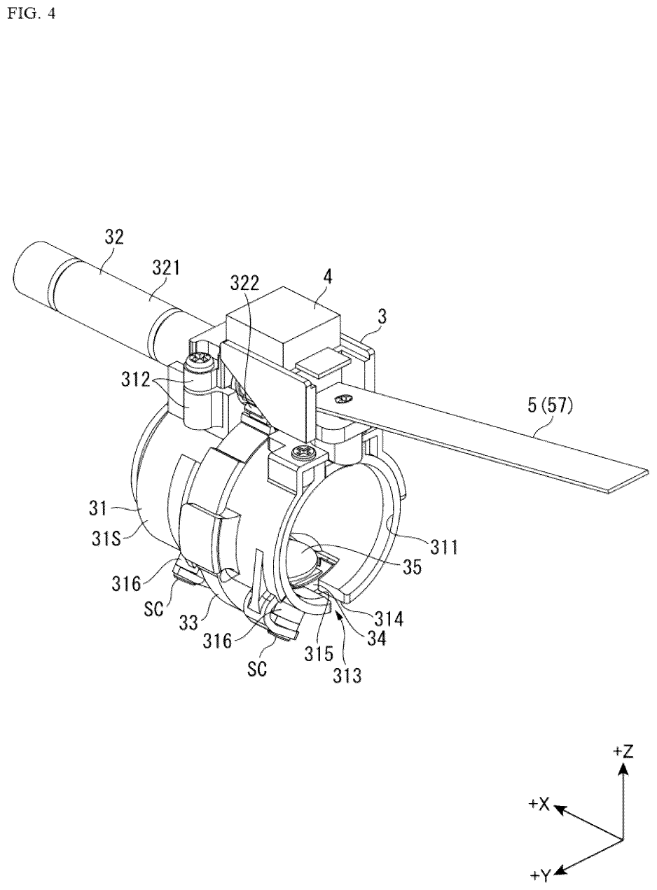

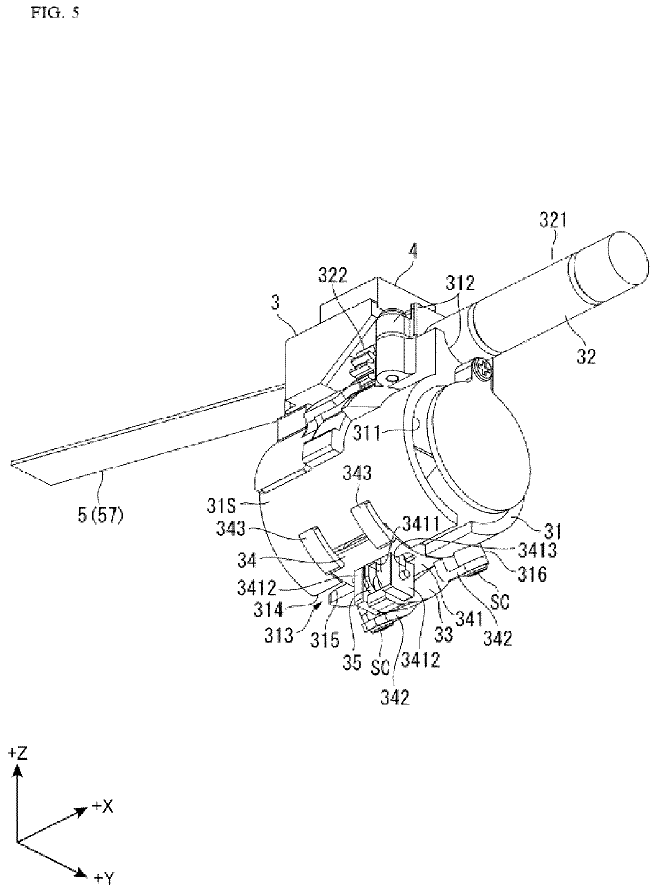

FIG. 4 is a perspective view of the pressing part 3 and the vibration generation part 4 when viewed from the −X direction and the +Z direction, and FIG. 5 is a perspective view of the pressing part 3 and the vibration generation part 4 when viewed from the +X direction and the-Z direction.

The plurality of pressing parts 3 are pressure sensing devices that press fingertips of the target finger F to give the user a sense of pressure. In the present embodiment, as shown in FIG. 2, the plurality of pressing parts 3 include a pressing part 3A mounted on a fingertip of a thumb FA, a pressing part 3B mounted on a fingertip of an index finger FB, and a pressing part 3C mounted on a fingertip of a middle finger FC.

As shown in FIGS. 4 and 5, the pressing part 3 includes a cylindrical member 31, a drive device 32, a slide member 33, a conversion member 34, and a protrusion member 35.

### Configuration of Cylindrical Member

The cylindrical member 31 is formed in a cylindrical shape with a cutout portion. The target finger F is inserted into the cylindrical member 31 in the +X direction, and thus the cylindrical member 31 is mounted on the fingertip of the target finger F. One end of a belt 57 of the bending restriction part 5, which will be described later, is fixed to the cylindrical member 31.

The cylindrical member 31 includes an opening 311, a fixing part 312, a cutout 313, and a support part 316.

The opening 311 is formed through the cylindrical member 31 along the +X direction. The target finger F is inserted into the opening 311 along the +X direction, and thus the fingertip of the target finger F is disposed inside the cylindrical member 31.

The fixing part 312 is a portion that protrudes in the +Z direction from an outer circumferential surface 31S of the cylindrical member 31, and the drive device 32 and the vibration generation part 4 are fixed to the fixing part 312.

The cutout 313 is formed along the +X direction in a portion of the cylindrical member 31 opposite to a portion where the fixing part 312 is provided. A distance between end edges 314 and 315 of the cylindrical member 31, which are spaced apart from each other by the cutout 313, is expanded when the target finger F is inserted into the cylindrical member 31. That is, the cylindrical member 31 has flexibility that allows an inner diameter of the cylindrical member 31 to be expanded. Accordingly, the cylindrical member 31 is fitted to the inserted target finger F.

A portion of the conversion member 34 is disposed between the end edges 314 and 315 facing each other in the Y-axis.

The support part 316 is disposed in the +Y direction relative to the edge 315 to support the conversion member 34. In other words, the conversion member 34 is attached to the support part 316 by a screw SC.

### Configuration of Drive Device

As shown in FIGS. 4 and 5, the drive device 32 is fixed to the fixing part 312 of the cylindrical member 31. The drive device 32 is controlled by the control part 7, which will be described later, to slide the slide member 33 along the outer circumferential surface 31S. For example, the drive device 32 includes a motor such as a stepping motor. The drive device 32 has a drive device body 321 and a pinion 322 that is rotated by the drive device body 321.

The pinion 322 is engaged with a rack 331 of the slide member 33, which will be described later, to slide the slide member 33.

### Configuration of Slide Member

The slide member 33 is formed in an arc shape along the outer circumferential surface 31S of the cylindrical member 31 and is attached to the cylindrical member 31. The slide member 33 is slid along the outer circumferential surface 31S by the drive device 32. The slide member 33 is formed to have a size that covers substantially ¾ of the outer circumferential surface 31S when viewed along the X-axis.

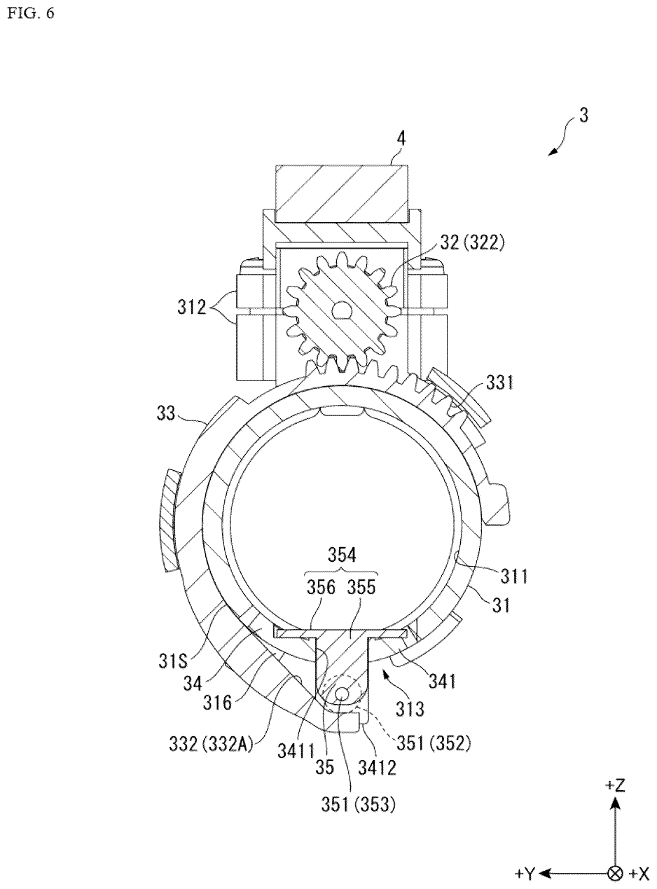

FIG. 6 is a view showing a cross-section of the pressing part 3 and the vibration generation part 4 along a YZ plane.

As shown in FIG. 6, the slide member 33 has the rack 331 and an abutment part 332.

The rack 331 is provided on an outer circumferential surface of the slide member 33. The rack 331 is engaged with the pinion 322. Therefore, when the pinion 322 is rotated, the slide member 33 is rotated in a clockwise or counterclockwise direction along the outer circumferential surface 31S of the cylindrical member 31 when viewed from the −Z direction. That is, the slide member 33 is slidably provided on the cylindrical member 31 in the clockwise or counterclockwise direction around a central axis of the cylindrical member 31 along the outer circumferential surface 31S of the cylindrical member 31.

In the present embodiment, the rack 331 is provided on a portion of the outer circumferential surface of the slide member 33, but may be provided on substantially the entire outer circumferential surface of the slide member 33.

The abutment part 332 is provided on an inner circumferential surface of the slide member 33. The abutment part 332 is provided at an end part of the slide member 33 in the counterclockwise direction when viewed from the −X direction. The abutment part 332 abuts on a roller part 352 of the protrusion member 35, which will be described later, and allows the protrusion member 35 to protrude into the cylindrical member 31 according to a sliding position of the slide member 33.

The abutment part 332 has an abutment surface 332A which is provided on the inner circumferential surface of the abutment part 332 and on which the roller part 352 abuts. The abutment surface 332A is inclined in a direction away from the outer circumferential surface 31S according to the movement thereof in a rotation direction of the slide member 33 when the protrusion member 35 protrudes into the cylindrical member 31.

Therefore, as will be described in detail later, when the slide member 33 is rotated in the counterclockwise direction when viewed from the −X direction, the abutment part 332 presses the roller part 352 toward an inner side of the cylindrical member 31.

The slide member 33 has flexibility that allows the slide member 33 to be displaced in response to the displacement of the cylindrical member 31, which is radially expanded when the target finger F is inserted.

### Configuration of Conversion Member

As shown in FIG. 5, the conversion member 34 is fixed to the outer circumferential surface 31S of the cylindrical member 31 and converts the rotation of the slide member 33 into linear motion of the protrusion member 35 toward either the inner side or outer side of the cylindrical member 31.

That is, the conversion member 34 restricts the rotation of the entire protrusion member 35 due to the rotation of the slide member 33, and converts the rotation of the slide member 33 into a movement of the protrusion member 35 along a radial direction of the cylindrical member 31.

As shown in FIG. 5, the conversion member 34 has a body part 341, a pair of fixing parts 342, and a pair of restriction parts 343.

The body part 341 is formed in a substantially rectangular shape when viewed from the −Z direction. The body part 341 is disposed between the end edges 314 and 315 when the conversion member 34 is fixed to the cylindrical member 31. The body part 341 has an opening 3411, a pair of protrusion parts 3412, and a pair of guide holes 3413.

The opening 3411 is formed in a substantially rectangular shape when viewed from the −Z direction, and is formed through the body part 341 along the Z-axis direction. The protrusion member 35 is disposed inside the opening 3411.

The pair of protrusion parts 3412 protrude in the −Z direction from an inner edge in the +X direction and an inner edge in the −X direction among inner edges of the opening 3411.

The pair of guide holes 3413 are provided in the pair of protrusions 3412. Specifically, between the pair of guide holes 3413, one guide hole 3413 is provided in the protrusion part 3412 in the +X direction, and the other guide hole 3413 is provided in the protrusion part 3412 in the −X direction. Each guide hole 3413 is an elongated hole having a long diameter in the Z-axis. The +Z direction is a moving direction of the protrusion member 35 toward the inner side of the cylindrical member 31.

A rotary shaft part 353 of the protrusion member 35, which will be described later, is inserted into each guide hole 3413. A short diameter of the guide hole 3413, that is, an inner diameter of the guide hole 3413 along the Y-axis, is a value obtained by adding a small clearance to an outer diameter of the rotary shaft part 353.

The pair of fixing parts 342 are provided at the end part of the body part 341 in the +Y direction. Each fixing part 342 is provided with a hole part through which the screw SC to be fixed to the support part 316 is inserted. In a state where the body part 341 is disposed between the end edges 314 and 315, the screw SC inserted through the hole of each fixing part 342 is fixed to the support part 316, thereby fixing the conversion member 34 to the outer circumferential surface 31S.

The pair of restriction parts 343 are provided at the end part of the body part 341 in the −Y direction.

The pair of restriction parts 343 make contact with the outer circumferential surface 31S when the cylindrical member 31 is radially expanded, thereby restricting the cylindrical member 31 from being radially expanded more than necessary. In addition, the pair of restriction parts 343 make contact with the outer circumferential surface 31S, thereby restricting the conversion member 34 together with the protrusion member 35 from moving in the +Z direction.

### Configuration of Protrusion Member

The protrusion member 35 is a pressing piece that moves to the inner side or outer side of the cylindrical member 31 as the slide member 33 slides so as to press the target finger F inserted into the cylindrical member 31 in the +Z direction. As shown in FIG. 6, the protrusion member 35 is disposed in the opening 3411 of the conversion member 34 so as to be movable to the inner side or outer side of the cylindrical member 31. The protrusion member 35 includes a roller member 351 and an insertion member 354.

The roller member 351 is rotatably supported by the insertion member 354 and is rotated in contact with the slide member 33. The roller member 351 includes the roller part 352 and the rotary shaft part 353.

The roller part 352 is formed in a disc shape. The roller part 352 makes contact with the abutment part 332 of the slide member 33 and is rotated about the rotary shaft part 353 as the slide member 33 slides.

The rotary shaft part 353 is supported by the insertion member 354 to form a rotary shaft of the roller part 352. Although not shown in the drawings, the rotary shaft part 353 protrudes from the roller part 352 in both the +X direction and the −X direction.

The insertion member 354 rotatably supports the roller member 351 and is inserted into the cylindrical member 31 to press the target finger F. The insertion member 354 has a pair of support parts 355 and a pressing part 356.

The pair of support parts 355 support the roller member 351. Each of the pair of support parts 355 has a through-hole through which the rotary shaft part 353 is inserted along the +Z direction.

Accordingly, the roller member 351 is rotatably supported about the rotary shaft along the X-axis by the insertion member 354. The rotary shaft part 353 inserted through the through-hole is inserted into the guide hole 3413 of the conversion member 34. As described above, the long diameter of the guide hole 3413 is along the Z-axis, and the short diameter of the guide hole 3413 is slightly larger than the outer diameter of the rotary shaft part 353. Therefore, the movement of the protrusion member 35 in the ±Y directions is restricted, and the movement of the protrusion member 35 in the ±Z directions is allowed.

The pressing part 356 is a portion of the protrusion member 35 facing the +Z direction. As shown in FIG. 6, the pressing part 356 is disposed in the cylindrical member 31 so as to make contact with the target finger F. In the present embodiment, a surface of the pressing part 356 facing the target finger F is a flat surface. However, the present invention is not limited thereto, and the surface of the pressing part 356 facing the target finger F may be a curved surface with a central portion protruding in the +Z direction, for example.

### Action of Pressing Part

When the pinion 322 of the drive device 32 is rotated and the slide member 33 is rotated in the counterclockwise direction along the outer circumferential surface 31S from a position shown in FIG. 6, the abutment part 332 of the slide member 33 makes contact with the roller part 352 of the protrusion member 35.

As described above, the movement of the protrusion member 35 in the ±X directions and the ±Y directions is restricted. Therefore, when the slide member 33 is further rotated in the counterclockwise direction, the roller part 352 moves in the +Z direction by the abutment surface 332A while rotating along the abutment surface 332A inclined with respect to the outer circumferential surface 31S. As a result, the protrusion member 35 is moved in the +Z direction, and the pressing part 356 presses the target finger F in the +Z direction.

The amount of insertion of the pressing part 356 into the cylindrical member 31 changes depending on the amount of sliding of the slide member 33. Therefore, a pressing force on the target finger F can be adjusted by adjusting the amount of sliding of the slide member 33.

In a state where the protrusion member 35 moves in the +Z direction, when the pinion 322 is rotated in the opposite direction so that the slide member 33 is rotated in the clockwise direction when viewed from the −X direction, the roller part 352 moves in the −Z direction while in contact with the abutment surface 332A. As a result, the protrusion member 35 moves in the +Z direction, so that the pressing force of the pressing part 356 on the target finger F decreases.

Furthermore, when the slide member 33 is further rotated in the clockwise direction, the amount of insertion of the pressing part 356 into the cylindrical member 31 decreases, and the pressing part 356 moves away from the target finger F.

In this way, the pressing part 3 can switch between applying and not applying a pressure to the target finger F depending on the rotation direction and rotation angle of the pinion 322, that is, the sliding direction and sliding amount of the slide member 33, and can adjust the pressing force on the target finger F.

### Configuration of Vibration Generation Part

Each of the plurality of vibration generation parts 4 applies vibration to the target hand HN. More specifically, the vibration generation part 4 generates the vibration that is applied to the target hand HN, thereby generating the illusion that the target hand HN makes contact with an object. In the present embodiment, as shown in FIG. 2, the plurality of vibration generation parts 4 include a vibration generation part 4A for the thumb FA, a vibration generation part 4B for the index finger FB, and a vibration generation part 4C for the middle finger FC. More specifically, the vibration generation part 4A is provided integrally with the pressing part 3A for the thumb FA, and applies the vibration to the pressing part 3A, thereby applying the vibration to the thumb FA of the target hand HN. In the present embodiment, the vibration generation part 4A is fixed to the cylindrical member 31 of the pressing part 3A. The same applies to the vibration generation parts 4B and 4C.

The vibration generation part 4 can include, for example, a voice coil motor controlled by the control part 7, which will be described later.

### Configuration of Bending Restriction Part

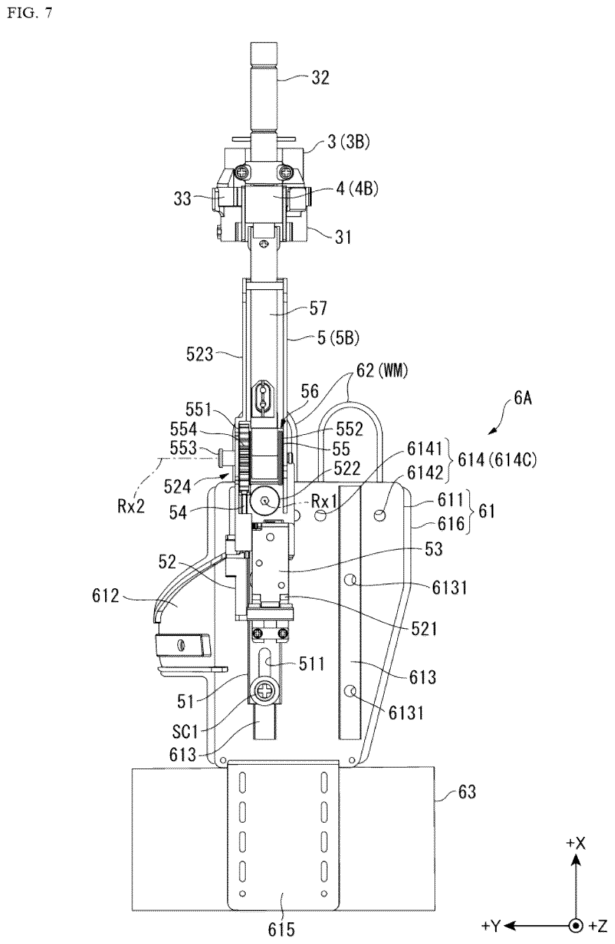

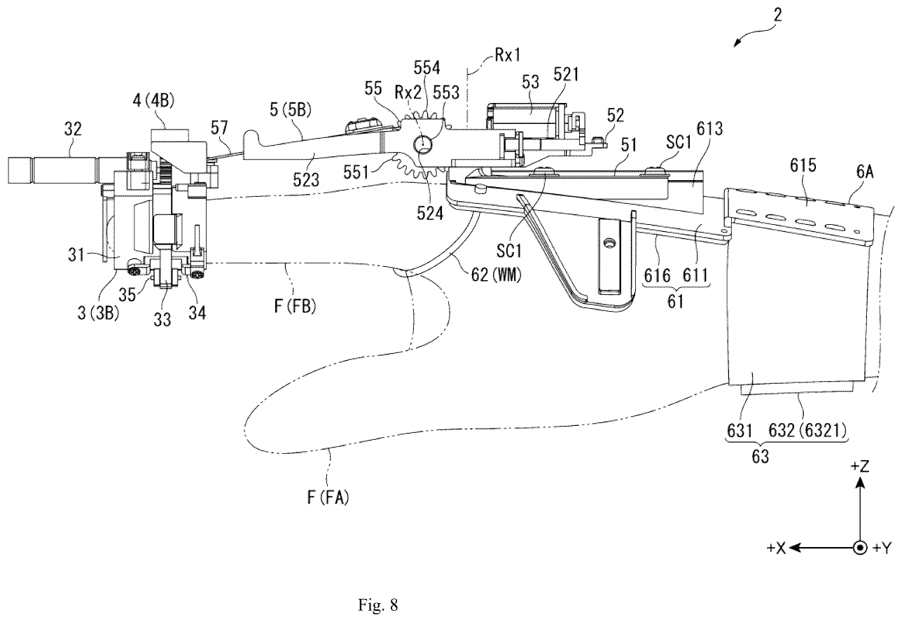

FIG. 7 is a plan view showing a bending restriction part 5B for the index finger FB when viewed from the +Z direction. FIG. 8 is a side view showing the bending restriction part 5B when viewed from the +Y direction.

As shown in FIG. 2, the plurality of bending restriction parts 5 are provided corresponding to the target finger F, and by restricting the bending of the target finger F toward the palm of the target hand HN, the user is given a feeling of touch when the target finger F makes contact with a virtual object or a feeling of touch when the target finger F grips a virtual object. The plurality of bending restriction parts 5 include a bending restriction part 5A for the thumb FA, the bending restriction part 5B for the index finger FB, and a bending restriction part 5C for the middle finger FC.

Among the bending restriction parts, the bending restriction part 5B includes a slide part 51, a support base 52, a solenoid element 53, a restriction member 54, a reel 55, a biasing member 56, and the belt 57, as shown in FIGS. 7 and 8.

The bending restriction parts 5A and 5C also have the same configuration as the bending restriction part 5B. Therefore, in the following, only the bending restriction part 5B will be described, and a description of the bending restriction parts 5A and 5C will be omitted.

### Configuration of Slide Part

The slide part 51 is slidably provided on a base part 61 of the mounting member 6A along the X-axis while supporting the support base 52. That is, the bending restriction part 5 is provided on the mounting member 6A so as to be movable along the +X direction in which the belt 57 extends. As shown in FIG. 7, the slide part 51 has a slot hole 511 along the X-axis.

A screw SC1 for fixing the slide part 51 to the base part 61 is inserted through the slot hole 511 along the −Z direction. The screw SC1 is fixed to a screw hole 6131 provided in the base part 61, so that the slide part 51 and the bending restriction part 5 are fixed to the base part 61.

In addition, the slide part 51 can slide along the X-axis by loosening the screw SC1 from the screw hole 6131, thereby adjusting a position of the slide part 51 on the base part 61 and a position of the bending restriction part 5 on the base part 61.

### Configuration of Support Base

The support base 52 is rotatably attached to the slide part 51 about a rotary shaft Rx1 along the Z-axis. The support base 52 has a support part 521, a rotary shaft part 522, a guide part 523, and a rotation support part 524.

The support part 521 is formed in a substantially rectangular shape that is long along the X-axis.

The support part 521 supports the solenoid element 53 on a surface facing the +Z direction.

The rotary shaft part 522 is provided at an end part of the support part 521 in the +X direction. The rotary shaft part 522 is a portion that is rotatably supported by the slide part 51 about the rotary shaft Rx1 along the Z-axis. That is, the bending restriction part 5 is rotatably provided on the mounting member 6A about the rotary shaft Rx1 along the Z-axis. The Z-axis is an axis that intersects both the +X direction in which the belt 57 extends and the +Y direction in which the fingers of the target hand HN are aligned.

The guide part 523 extends linearly from the support part 521 in the +X direction. That is, the guide part 523 extends linearly along the target finger F from the base part 61 of the mounting member 6A via the support part 521. The guide part 523 guides the sliding of the belt 57 along the X-axis. A length of the guide part 523 on the X-axis is substantially the same as a length from a metacarpophalangeal joint to a proximal interphalangeal joint of the target finger F when the target finger F is any of the index finger FB, the middle finger FC, the ring finger, and the little finger, and is substantially the same as a length from the metacarpophalangeal joint to an interphalangeal joint of the thumb when the target finger F is the thumb FA.

The rotation support part 524 is provided at a portion of the guide part 523 in the −X direction. In other words, the rotation support part 524 is provided between the support part 521 and the guide part 523. The rotation support part 524 rotatably supports the reel 55 about a rotary shaft Rx2 along the Y-axis.

### Configuration of Solenoid Element

The solenoid element 53 is disposed on the support part 521 to move the restriction member 54 along the X-axis. The operation of the solenoid element 53 is controlled by the control part 7, which will be described later, to move the restriction member 54 to either a position in the +X direction or a position in the −X direction.

### Configuration of Restriction Member

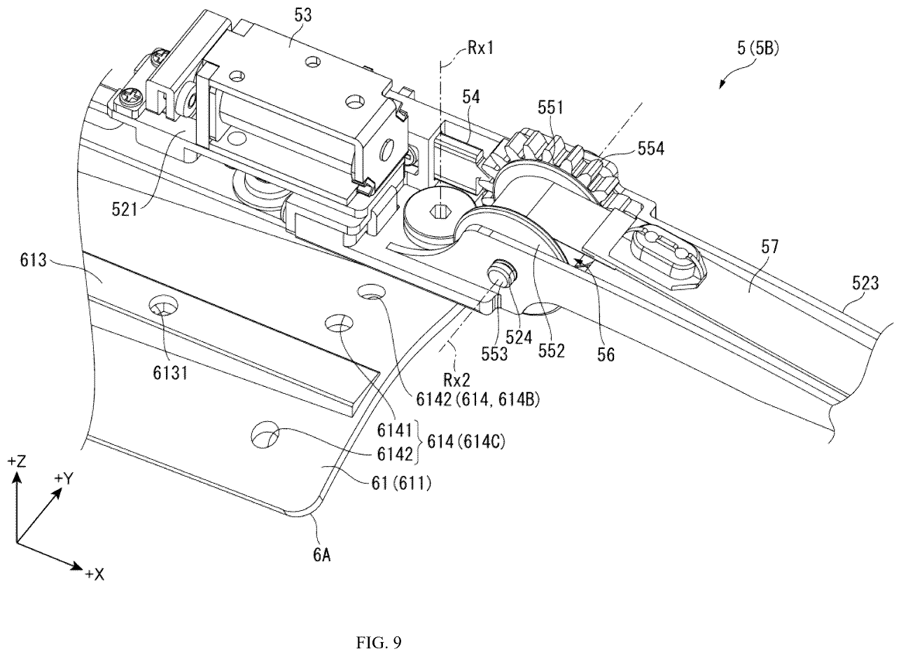

FIG. 9 is an enlarged perspective view showing a portion of the bending restriction part 5B.

The restriction member 54 is slid along the X-axis by the solenoid element 53 to restrict or allow the rotation of the reel 55, thereby restricting or allowing the bending of the target finger F.

When the restriction member 54 is disposed at a restriction position in the +X direction by the solenoid element 53, a tip end part of the restriction member 54 in the +X direction is engaged with the reel 55 as shown in FIG. 9. Accordingly, the rotation of the reel 55 is restricted.

When the restriction member 54 is disposed at an allowance position in the −X direction by the solenoid element 53, the engagement with the reel 55 is released. Accordingly, the rotation of the reel 55 is allowed.

### Configuration of Reel

The reel 55 is provided on the belt 57 opposite to an engagement portion of the target finger F, and rotates according to the movement of the belt 57 to wind and feed out the belt 57. As shown in FIGS. 7 and 9, the reel 55 is rotatably supported by the rotation support part 524 about the rotary shaft Rx2 along the Y-axis while being connected to the belt 57. The reel 55 has a pair of rotation parts 551 and 552 and a shaft part 553 connecting the pair of rotation parts 551 and 552 to each other.

Each of the pair of rotation parts 551 and 552 is formed in a disc shape based on the shaft part 553 serving as the center. Between the pair of rotation parts 551 and 552, an engagement part 554 is provided on an outer circumferential surface of the rotation part 551 in the +Y direction.

As shown in FIG. 9, the engagement part 554 includes a plurality of teeth provided along a circumferential direction of the reel 55 about the rotary shaft Rx2. When the restriction member 54 is inserted between the plurality of teeth of the engagement part 554, the rotation of the reel 55 is restricted, and thus the belt 57 cannot be fed out by the reel 55. On the other hand, when the engagement between the engagement part 554 and the restriction member 54 is released so that the rotation of the reel 55 is allowed, the belt 57 is allowed to be pulled out from the reel 55, that is, the belt 57 is allowed to be fed out by the reel 55.

### Configuration of Biasing Member

The biasing member 56 biases the reel 55 in a direction in which the reel 55 winds the belt 57, thereby generating tension in the belt 57. Although not shown in detail, in the present embodiment, the biasing member 56 is formed by a spiral spring. However, the present invention is not limited thereto, and the configuration of the biasing member 56 is not limited to a spiral spring, and may be other configurations as long as the biasing member 56 can bias the reel 55.

### Configuration of Belt

The belt 57 extends along the guide part 523. More specifically, an end part of the belt 57 in the −X direction is connected to the reel 55, and an end part of the belt 57 in the +X direction is connected to the cylindrical member 31 of the pressing part 3. In other words, the belt 57 extends in the +X direction from the reel 55 and is connected to the pressing part 3, and an engagement portion of the belt 57 with the target finger F is the pressing part 3.

In the present embodiment, the belt 57 is made of a material with low stretchability. As a result, the bending of the target finger F is restricted at a timing when the feeding-out of the belt 57 is restricted by the reel 55.

### Configuration of Mounting Member

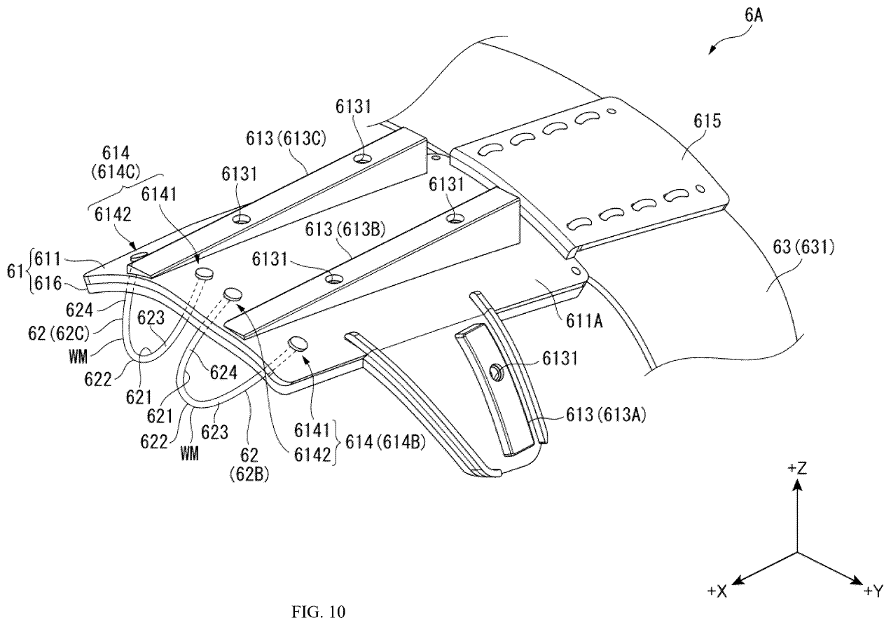

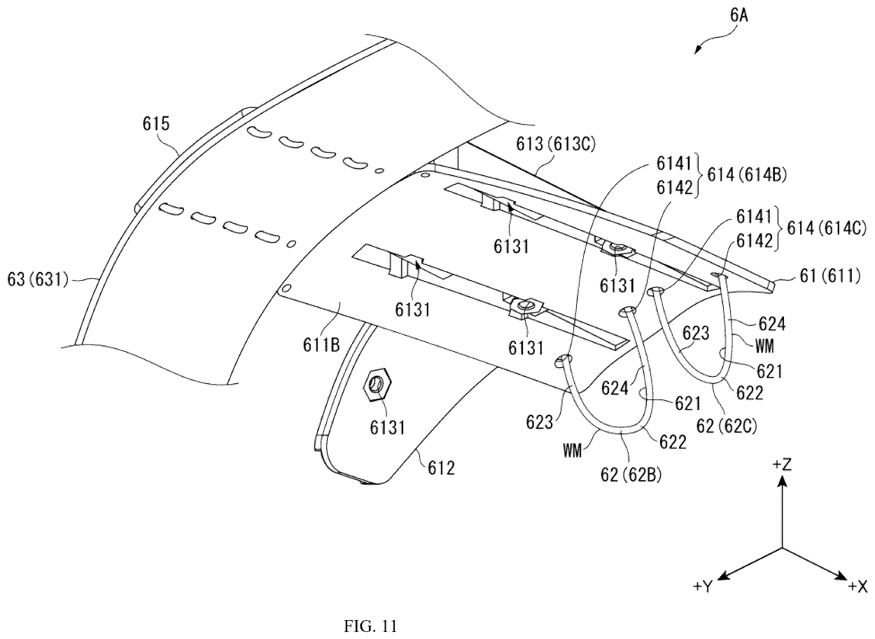

FIGS. 10 and 11 are perspective views showing the mounting member 6A. More specifically, FIG. 10 is a perspective view of the mounting member 6A when viewed from a fingertip side of the target hand HN in a direction toward the back of the target hand HN. FIG. 11 is a perspective view of the mounting member 6A when viewed from a wrist side of the target hand HN in a direction opposite to the direction toward the back of the target hand HN. In FIG. 11, a cushioning material 616 is not shown.

The mounting member 6A is a member that supports the vibration generation part 4 and the bending restriction part 5 and is mounted on the target hand HN. As shown in FIGS. 10 and 11, the mounting member 6A has the base part 61, a ring-shaped part 62, and a mounting part 63.

The configuration of the base part 61 will be described in detail later.

### Configuration of Ring-Shaped Part

At least one ring-shaped part 62 is provided on the base part 61 and is mounted on the target finger F. More specifically, the ring-shaped part 62 is disposed at the base of the target finger F to apply a pulling force of pulling the base part 61 toward the back of the target hand HN to the base part 61.

As a result, the ring-shaped part 62 restricts the base part 61 from moving away from the back of the target hand HN.

In the present embodiment, two ring-shaped parts 62 are provided on the base part 61. Between the two ring-shaped parts 62, one ring-shaped part 62 is a ring-shaped part 62B mounted on the index finger FB, and the other ring-shaped part 62 is a ring-shaped part 62C mounted on the middle finger FC.

The ring-shaped part 62 has an insertion hole 621, a contact part 622, and connection parts 623 and 624.

The target finger F is inserted through the insertion hole 621. For example, the index finger FB, which is one of the target fingers F, is inserted through the insertion hole 621 of the ring-shaped part 62B. In addition, for example, the middle finger FC, which is another one of the target fingers F, is inserted through the insertion hole 621 of the ring-shaped part 62C.

The contact part 622 makes contact with a ventral portion of the target finger F inserted through the insertion hole 621. That is, the ring-shaped part 62 makes contact with the ventral portion of the target finger F. The contact part 622 extends in a direction intersecting an extending direction of the target finger F.

The connection parts 623 and 624 connect the contact part 622 to the base part 61. Specifically, the connection part 623 connects one end of the contact part 622 to the base part 61, and the connection part 624 connects the other end of the contact part 622 to the base part 61. The connection parts 623 and 624 have stretchability. Therefore, the connection parts 623 and 624 pull the base part 61 toward a ventral side of the target finger, that is, toward the back of the target hand HN.

In the present embodiment, the ring-shaped part 62 is formed in a ring shape by fixing one end and the other end of a wire WM, which is formed by an elastic material such as rubber, to the base part 61. That is, the contact part 622 and the connection parts 623 and 624 are a portion of the ring-shaped part formed in a ring shape by the wire WM. Therefore, the ring-shaped part 62 having the above-described configuration can be easily formed. In addition, by adjusting a length of the wire WM, an inner diameter of each of the ring-shaped parts 62B and 62C can be easily adjusted.

The contact part 622 does not necessarily have stretchability. Even in this case, the connection part 623 connected to one end of the contact part 622 and the connection part 624 connected to the other end of the contact part 622 have stretchability, so that the above-described pulling force can be applied to the base part 61.

In addition, the contact part 622 may be formed by a cylindrical body through which the wire WM is inserted. In this case, the cylindrical body moves along the wire WM, so that even if the inner diameter of the ring-shaped part 62 is adjusted, a position of the contact part 622 formed by the cylindrical body can be easily adjusted.

### Configuration of Mounting Part

The mounting part 63 is attached to the base part 61 and is mounted on the wrist of the target hand HN. As shown in FIG. 8, the mounting part 63 has a band 631 and a tightening mechanism 632.

The band 631 is wound around the wrist of the target hand HN. A portion of the band 631 is fixed to the fixing part 615 of the base part 61. In the present embodiment, the band 631 is fixed to the fixing part 615 by sewing.

The tightening mechanism 632 has an operation part 6321 that is operated by the user, and tightens the band 631 in response to the operation of the operation part 6321. An example of the mounting part 63 having the tightening mechanism 632 includes a dial-type wristband. The dial-type wristband is a wristband in which, when the operation part 6321, which is a dial, is rotated, a wire (not shown) inside the band 631 is wound, thereby tightening the band 631.

### Configuration of Base Part

As shown in FIG. 8, the base part 61 is disposed on the back of the target hand HN. The base part 61 has a base part body 611 shown in FIGS. 10 and 11, and a cushioning material 616 shown in FIG. 10.

### Configuration of Base Part Body

As shown in FIG. 10, the base part body 611 is formed in a shape along the back and wrist of the target hand HN when viewed from a position facing the back of the target hand HN. The base part body 611 has an extension part 612, a plurality of support parts 613, a plurality of attachment parts 614, and a fixing part 615.

The extension part 612 is a portion of the base part body 611 protruding in the +Y direction. That is, the extension part 612 extends from the base part body 611 in the +Y direction in which the thumb extends from the back of the target hand HN.

The plurality of support parts 613 include a support part 613A supporting the bending restriction part 5A for the thumb FA, a support part 613B supporting the bending restriction part 5B for the index finger FB, and a support part 613C supporting the bending restriction part 5C for the middle finger FC. The support parts 613A, 613B, and 613C stand up in the +Z direction from a surface 611A of the base part body 611 facing the +Z direction. The support part 613A is provided on the extension part 612 and extends along the +Y direction. Each of the support parts 613A and 613B extends along the +X direction.

Each support part 613 has a plurality of screw holes 6131 to which the screw SC1 for fixing the slide part 51 of the corresponding bending restriction part 5 is fixed. Specifically, the support part 613A has one screw hole 6131 for fixing the slide part 51 of the bending restriction part 5A. The support part 613B has two screw holes 6131 for fixing the slide part 51 of the bending restriction part 5B. The two screw holes 6131 are spaced apart from each other on the X-axis. The same applies to the two screw holes 6131 of the support part 613C.

The plurality of attachment parts 614 are portions to which the ring-shaped part 62 is attached, and are provided on the opposite side of the base part 61 from the fixing part 615 to which the mounting part 63 is fixed. The plurality of attachment parts 614 are provided corresponding to the ring-shaped part 62 at a portion of the base part body 611 in the +X direction, which is an extending direction of the index finger FB and the middle finger FC. That is, the plurality of attachment parts 614 include an attachment part 614B to which the ring-shaped part 62B is attached, and an attachment part 614C to which the ring-shaped part 62C is attached.

Each attachment part 614 has a hole part through which the wire WM constituting the ring-shaped part 62 is inserted. That is, the attachment part 614 has a first hole part 6141 through which one end of the wire WM constituting the ring-shaped part 62 is inserted, and a second hole part 6142 through which the other end of the wire WM is inserted. One end of the wire WM inserted through the first hole part 6141 in the +Z direction is restricted from coming off from the first hole part 6141 by forming a single knot, and the other end of the wire WM inserted through the second hole part 6142 in the +Z direction is prevented from coming off from the second hole part 6142 by a similar method.

The fixing part 615 is a plate-shaped portion of the base part body 611 extending in the −X direction. In other words, the fixing part 615 is provided at an end part of the base part body 611 opposite to the end part close to the plurality of attachment parts 614.

The band 631 of the mounting part 63 is fixed to the fixing part 615 by sewing or the like.

### Configuration of Cushioning Material

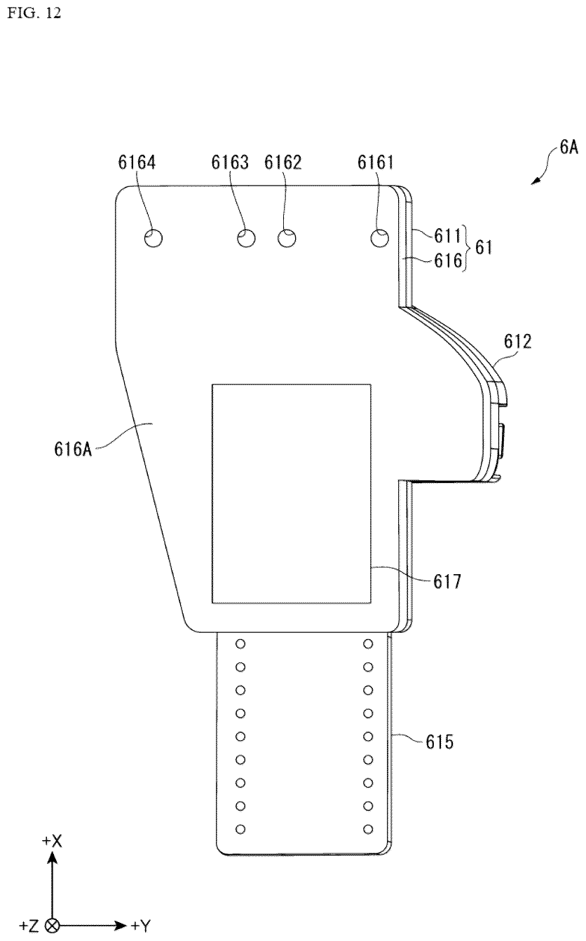

FIG. 12 is a view showing the cushioning material 616 when viewed from the opposite side of the base part body 611.

As shown in FIG. 10, the cushioning material 616 is an elastic member that is disposed between the base part body 611 and the back of the target hand HN, and brings the base part body 611 into close contact with the back of the target hand HN. In the present embodiment, the cushioning material 616 is provided on a surface 611B of the base part body 611 facing the −Z direction shown in FIG. 11. When viewed from the base part body 611, an outer shape of the cushioning material 616 is substantially the same as an outer diameter of the base part body 611 or is slightly larger than the outer diameter of the base part body 611. In present embodiment, the cushioning material 616 is made of an elastic material such as urethane resin or sponge. That is, the cushioning material 616 has elasticity.

As shown in FIG. 12, the cushioning material 616 has a hole part 6161 through which the connection part 623 of the ring-shaped part 62B is inserted along the Z-axis, and a hole part 6162 through which the connection part 624 of the ring-shaped part 62B is inserted along the Z-axis.

Furthermore, the cushioning material 616 has a hole part 6163 through which the connection part 623 of the ring-shaped part 62C is inserted along the Z-axis, and a hole part 6164 through which the connection part 624 of the ring-shaped part 62C is inserted along the axis.

An adhesive sheet 617 is provided on a contact surface 616A of the cushioning material 616 making contact with the back of the target hand HN. That is, the base part 61 has the adhesive sheet 617 provided on the cushioning material 616.

The adhesive sheet 617 is provided on the contact surface 616A in a region including the center of the contact surface 616A and close to the wrist of the target hand HN. Therefore, the adhesive sheet 617 includes the center of the back of the target hand HN and makes contact with a portion close to the wrist.

The adhesive sheet 617 can restrict the base part 61 from swinging relative to the back of the target hand HN, so that the base part 61 can be stably mounted on the back of the target hand HN. A position of adhesive sheet 617 on the contact surface 616A is not limited to the above and can be changed as appropriate. In addition, the number and size of the adhesive sheets 617 can also be changed as appropriate.

### Action of Haptic Force Feedback Device

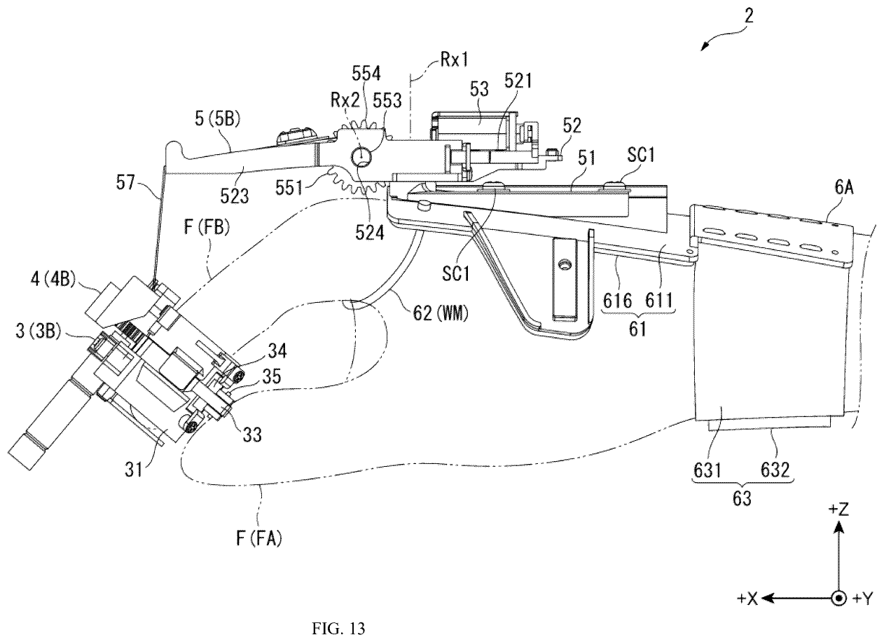

FIG. 13 is a side view of the haptic force feedback device 2 when the index finger FB is bent, as viewed from the +Y direction. In FIG. 13, among the plurality of bending restriction parts 5, the bending restriction part 5B for the index finger FB is shown, and the bending restriction part 5A for the thumb FA and the bending restriction part 5C for the middle finger FC are not shown.

In a state where the rotation of the reel 55 is not restricted by the restriction member 54, the belt 57 can be pulled out from the reel 55 and is stretched in the +X direction in response to the bending of the target finger F, as shown in FIG. 13. In detail, in a state where the rotation of the reel 55 is not restricted by the restriction member 54, the belt 57 is pulled out in the +Z direction in response to the bending of the target finger F while resisting a biasing force of the biasing member 56.

Therefore, a length of the belt 57 from the reel 55 increases as the target finger F bends.

In this case, the ring-shaped part 62 follows a bending motion of the target finger F so that the connection parts 623 and 624 of the ring-shaped part 62 extend, and the base part 61 provided with the ring-shaped part 62 is pulled in a direction of bringing the base part 61 into close contact with the back of the target hand HN. Accordingly, the base part 61 is brought into close contact with the back of the target hand HN.

In the state where the rotation of the reel 55 is not restricted by the restriction member 54, since the belt 57 cannot be pulled out from the reel 55, the length of the belt 57 from the reel 55 is not changed. Accordingly, the bending of the target finger F is restricted. That is, the solenoid element 53 switches the position of the restriction member 54 to switch between a restriction state, in which the movement of the belt 57 connected to the reel 55 is restricted to restrict the bending of the target finger F, and an allowance state in which the movement of the belt 57 is allowed to allow the bending of the target finger F.

Therefore, at a timing when it is determined that the target finger F makes contact with a virtual object, the rotation of the reel 55 is restricted by the restriction member 54, thereby instantaneously restricting the bending of the target finger F. Accordingly, the user can be given the sensation of an object making contact with the target finger F.

When the target finger F is slightly bent, and even when the target finger F is not bent, the base part 61 is pulled in the direction of bringing the base part 61 into close contact with the back of the target hand HN by the connection parts 623 and 624 of the ring-shaped part 62. Accordingly, the base part 61 is brought into close contact with the back of the target hand HN.

In this way, even when the target finger F is stretched and bent, the mounting part 63 provided on the fixing part 615 is fixed to the wrist of the target hand HN, and the ring-shaped parts 62B and 62C attached to the plurality of attachment parts 614 are attached to the bases of the index finger FB and the middle finger FC. Accordingly, the base part 61 that supports the bending restriction parts 5A, 5B, and 5C is maintained while being brought into close contact with the back of the target hand HN. In particular, the end part of the base part 61 in the +X direction, that is, the end part of the base part 61 opposite the mounting part 63, is pulled toward the back of the target hand HN by the pulling force of the wire WM constituting the ring-shaped parts 62B and 62C.

Accordingly, the base part 61 is brought into close contact with the back of the target hand HN. In this case, since the cushioning material 616 is compressed between the back of the target hand HN and the base part body 611, the base part 61 is further brought into close contact with the back of the target hand HN. Furthermore, the adhesive sheet 617 provided on the cushioning material 616 adheres to the back of the target hand HN, thereby restricting the swinging of the base part 61 relative to the back of the target hand HN.

Accordingly, it is possible to enhance the wearing comfort of the mounting member 6A and the haptic force feedback device 2 on the target hand HN.

### Configuration of Control Part

The control part 7 shown in FIG. 1 controls the haptic force feedback device 2 based on the control signal acquired from the information processing device 12. Specifically, the control part 7 controls the plurality of pressing parts 3, the plurality of vibration generation parts 4, and the plurality of bending restriction parts 5 based on the control signal from the information processing device 12.

The control part 7 is provided, for example, on the band 631 of the mounting member 6A.

Based on the acquired control signal, the control part 7 can individually perform the following operations of pressing the ventrum of the target finger F using the pressing part 3, generating vibration for the target finger F using the vibration generation part 4, and restricting bending of the target finger F using the bending restriction part 5, and can also perform the operations simultaneously.

For example, when it is determined that the posture of the target hand HN, which is detected by the detection device 11 and calculated by the information processing device 12, is a posture of gripping an object, the information processing device 12 outputs a predetermined control signal to the haptic force feedback device 2. The control part 7, which has acquired the control signal, operates the pressing part 3, the vibration generation part 4, and the bending restriction part 5 to simultaneously perform the pressing of the ventrum of the target finger F, the generating of the vibration for the target finger F, and the restricting of the bending of the target finger F. Accordingly, the bending of the target finger F is restricted, the ventrum of the target finger F is pressed, and furthermore, the vibration is applied to the target finger F, so that the user can be given the sensation of making contact with a virtual object.

### Effect of First Embodiment

The haptic force feedback system 1 according to the present embodiment described above provides the following effects.

The mounting member 6A is used in the haptic force feedback device 2 that provides haptic force feedback to the target hand HN, which is a hand. The mounting member 6A is attached to the target hand HN. The mounting member 6A has the base part 61, the ring-shaped part 62, and the mounting part 63.

The base part 61 is disposed in contact with the back of the target hand HN.

The mounting part 63 is provided at a portion close to one end of the base part 61, and is mounted on the wrist of the target hand HN.

The ring-shaped part 62 is provided at a portion close to the other end of the base part 61. The target finger F of the target hand HN is inserted into the ring-shaped part 62. Specifically, the index finger FB, which is one of the target fingers F, is inserted into the ring-shaped part 62B, and the middle finger FC, which is another one of the target fingers F, is inserted into the ring-shaped part 62C.

The ring-shaped part 62 is disposed at the base of the target finger F inserted into the ring-shaped part 62 and makes contact with the ventral portion of the target finger F.

According to the configuration, in a state where the base part 61 is disposed in contact with the back of the target hand HN, the mounting part 63 provided on the base part 61 is mounted on the wrist, and the target finger F is inserted into the ring-shaped part 62 provided on the base part 61. In this case, the ring-shaped part 62 makes contact with the ventral portion at the base of the target finger F. Accordingly, the ring-shaped part 62 follows the bending motion of the target finger F, and the base part 61 provided with the ring-shaped part 62 is pulled in the direction of bringing the base part 61 into close contact with the back of the target hand HN, so that the base part 61 can be brought into close contact with the back of the target hand HN. Therefore, the base part 61 can be prevented from being lifted away from the back of the target hand HN, and so that the mounting member 6A can be stably mounted on the target hand HN.

In the mounting member 6A, the ring-shaped part 62 applies the pulling force toward the back of the target hand HN to the base part 61.

According to the configuration, the pulling force is applied to the base part 61, so that it is possible to easily bring the base part 61 into close contact with the back of the target hand HN. Therefore, the mounting member 6A can be mounted on the target hand HN more stably.

In the mounting member 6A, the ring-shaped part 62 is formed by a stretchable wire WM provided in a ring shape on the base part 61.

According to the configuration, when the ring-shaped part 62 is disposed at the base of the inserted target finger F, the base part 61 provided with the ring-shaped part 62 is pulled by the wire WM constituting the ring-shaped part 62 in a direction approaching the back of the target hand HN based on the ventral portion at the base of the target finger F. That is, since the wire WM applies the pulling force to the base part 61, it is possible to easily bring the base part 61 into close contact with the back of the target hand HN. Therefore, the mounting member 6A can be mounted on the target hand HN more stably.

In the mounting member 6A, the base part 61 has the first hole part 6141 and the second hole part 6142.

One end of the wire WM constituting the ring-shaped part 62 is inserted into the first hole part 6141, and the other end of the wire WM is inserted into the second hole part 6142.

The first hole part 6141 and the second hole part 6142 are provided at the portion of the base part 61 opposite to the mounting part 63.

According to the configuration, the wire WM constituting the ring-shaped part 62 can be disposed at a position of the base part 61 corresponding to the base of the target finger F. Therefore, the pulling force can be easily applied to the base part 61, and the mounting member 6A can be mounted on the target hand HN more stably.

In the mounting member 6A, the mounting part 63 has the band 631 and the tightening mechanism 632.

The band 631 is wound around the wrist of the target hand HN.

The tightening mechanism 632 tightens the band 631 around the wrist of the target hand HN.

According to the configuration, the tightening mechanism 632 can adjust tightness of the band 631 around the wrist. Therefore, the wearing comfort of the mounting member 6A on the target hand HN can be enhanced, and the mounting member 6A can be mounted on the hand more stably.

In the mounting member 6A, the base part 61 has the base part body 611 and the cushioning member 616.

The cushioning material 616 has elasticity. The cushioning material 616 is provided between the base part body 611 and the back of the target hand HN so as to make contact with the back of the target hand HN.

According to the configuration, the cushioning material 616 is elastically deformed, thereby allowing the base part body 611 to be stably mounted on the back of the target hand HN.

In the mounting member 6A, the base part 61 has the adhesive sheet 617. The adhesive sheet 617 is provided on the contact surface 616A of the cushioning material 616 in contact with the back of the target hand HN.

According to the configuration, the adhesive sheet 617 provided on the cushioning material 616 makes contact with the back of the target hand HN, so that it is possible to prevent the displacement of the cushioning material 616 and the base part body 611 relative to the back of the target hand HN. Therefore, the base part 61 can be stably mounted on the back of the target hand HN, and the mounting member 6A can be stably mounted on the target hand HN.

The haptic force feedback device 2 includes the above-described mounting member 6A, the pressing part 3, the vibration generation part 4, and the bending restriction part 5.

The pressing part 3 presses the ventrum of the target finger F. In present embodiment, the haptic force feedback device 2 has the pressing part 3A that presses the ventrum of the thumb FA, the pressing part 3B that presses the ventrum of the index finger FB, and the pressing part 3C that presses the ventrum of the middle finger FC. Any of the thumb FA, index finger FB, and middle finger FC corresponds to the first finger.

The plurality of vibration generation part 4 applies vibration to the target finger F. In present embodiment, the haptic force feedback device 2 has the vibration generation part 4A that applies vibration to the thumb FA, the vibration generation part 4B that applies vibration to the index finger FB, and the vibration generation part 4C that applies vibration to the middle finger FC.

The bending restriction part 5 extends from the base part 61 along the target finger F to restrict the bending of the target finger F. In present embodiment, the haptic force feedback device 2 has the bending restriction part 5A that restricts the bending of the thumb FA, the bending restriction part 5B that restricts the bending of the index finger FB, and the bending restriction part 5C that restricts the bending of the middle finger FC.

According to the configuration, the mounting member 6A is stably mounted on the target hand HN, so that the pressing part 3 can effectively press the target finger F. In addition, the vibration generated by the vibration generation part 4 can be effectively transmitted to the target finger F, and the bending restriction part 5 can effectively restrict the bending of the target finger F. That is, as for one target finger F, pressing by the pressing part 3, generation of vibration by the vibration generation part 4, and restriction of bending by the bending restriction part 5 can be effectively performed. Accordingly, for example, the user can be given the sensation of making contact with an object.

### Second Embodiment

Next, a second embodiment of the present invention will be described.

A haptic force feedback system according to the present invention has the same configuration as the haptic force feedback system 1 according to the present embodiment, but is different from the haptic force feedback system 1 according to the present embodiment in the base part and the ring-shaped part of the mounting member. In the following description, portions that are the same or substantially the same as portions already described will be given the same reference numerals, and a description thereof will be omitted.

### Schematic Configuration of Haptic Force Feedback System and Haptic Force Feedback Device

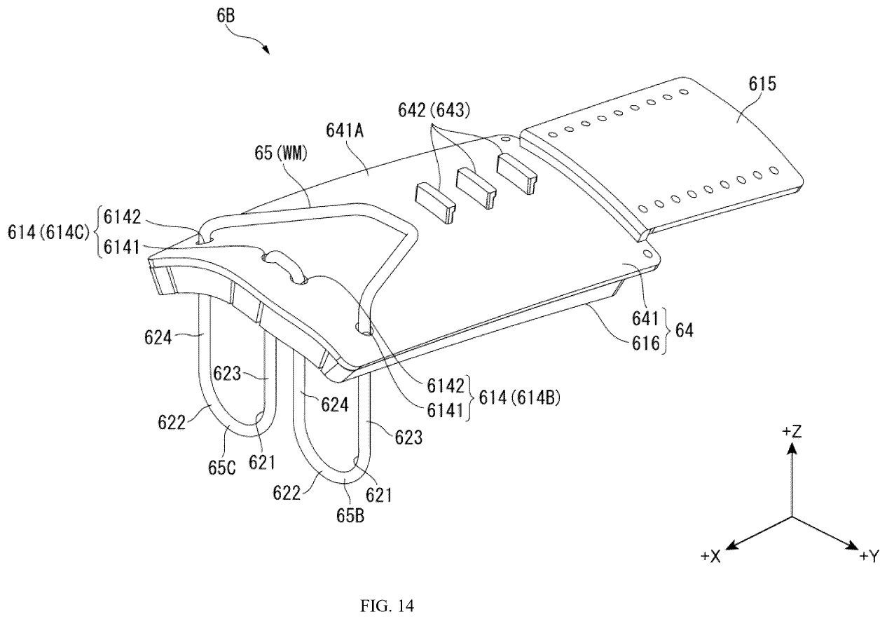

FIG. 14 is a perspective view showing a mounting member 6B of a haptic force feedback device included in the haptic force feedback system according to the present embodiment.

The haptic force feedback system according to the present embodiment has the same configuration and functions as the haptic force feedback system 1 according to the first embodiment, except that the haptic force feedback system has a mounting member 6B shown in FIG. 14 instead of the mounting member 6A according to the first embodiment. That is, the haptic force feedback device according to the present embodiment has the same configuration and functions as the haptic force feedback device 2 according to the first embodiment, except that the haptic force feedback device has the mounting member 6B instead of the mounting member 6A.

### Configuration of Mounting Member

The mounting member 6B is mounted on the back of the target hand HN, the target finger F, and the wrist, in the same manner as the mounting member 6A according to the first embodiment. The mounting member 6B has the same configuration and functions as the mounting member 6A according to the first embodiment, except that the mounting member 6B includes a base part 64 and a ring-shaped part 65 instead of the base part 61 and the ring-shaped part 62 according to the first embodiment. That is, the mounting member 6B includes the base part 64, the ring-shaped part 65, and a mounting part 63.

### Configuration of Base Part

The base part 64 is disposed on the back of the target hand HN in the same manner as the base part 61. The base part 64 has an adhesive sheet 617 that is not shown in FIG. 14, in addition to a base part body 641 and a cushioning material 616.

In the same manner as the base part body 611 according to the first embodiment, the base part body 641 is formed in a shape along the back and wrist of the target hand HN when viewed from a position facing the back of the target hand HN, and is disposed on the back of the target hand HN while being interposed between the cushioning material 616 and the adhesive sheet 617.

The base part body 641 has the same configuration and functions as the base part body 611, except that the base part body 641 further includes an adjustment part 642. That is, the base part body 641 has a plurality of support parts 613 (not shown), in addition to an extension part 612, a plurality of attachment parts 614, a fixing part 615, and the adjustment part 642.

As will be described in more detail later, one wire WM constituting the ring-shaped part 65 is alternately inserted through each of hole parts 6141 and 6142 constituting an attachment part 614B and each of hole parts 6141 and 6142 constituting an attachment part 614C.

The adjustment part 642 adjusts an inner diameter of each ring-shaped part 65 by locking the ring-shaped wire WM that constitutes the ring-shaped part 65. More specifically, the adjustment part 642 has a plurality of hooks 643 for locking the wire WM.

The plurality of hooks 643 are respectively arranged side by side from the ring-shaped part 65 toward the mounting part 63 on a surface 641A of the base part body 641 opposite the back of the target hand HN. That is, the plurality of hooks 643 are arranged side by side in a direction away from the attachment part 614.

Each hook 643 is inserted through the hole parts 6141 and 6142 that constitute the plurality of attachment parts 614 to lock a portion of the knotted wire WM. As will be described in detail later, the inner diameter of each ring-shaped part 65 is changed depending on a position of the hook 643 for locking the wire WM among the plurality of hooks 643.

### Configuration of Ring-Shaped Part

The ring-shaped part 65 is mounted on the target finger F in the same manner as the ring-shaped part 62 according to the first embodiment. Two ring-shaped parts 65 are provided, in which, between the two ring-shaped parts 65, one ring-shaped part 65 is a ring-shaped part 65B mounted on the index finger FB, and the other ring-shaped part 65 is a ring-shaped part 65C mounted on the middle finger FC.

In this case, the wire WM constituting the ring-shaped part 62B and the wire WM constituting the ring-shaped part 62C according to the first embodiment are individually attached to the base part 61. That is, the wire WM constituting the ring-shaped part 62B is a wire different from the wire WM constituting the ring-shaped part 62C.

In contrast, in present embodiment, each of the ring-shaped parts 65B and 65C is formed by a single wire WM attached to the plurality of attachment parts 614. In more detail, one wire WM is disposed so as to thread through the hole parts 6141 and 6142 that constitute the attachment parts 614B and 614C, and is tied into a ring shape such that an insertion hole 621 through which the index finger FB is inserted and an insertion hole 621 through which the middle finger FC is inserted are formed. Specifically, the wire WM is inserted through the first hole part 6141 of the attachment part 614B in the −Z direction, and then is inserted through the second hole part 6142 of the attachment part 614B in the +Z direction, and furthermore, the wire WM is inserted through the first hole part 6141 of the attachment part 614C in the −Z direction, and then is inserted through the second hole part 6142 of the attachment part 614C in the +Z direction. Then, the wire WM, which is inserted through the second hole part 6142 of the attachment part 614C in the +Z direction, is tied into a portion of the attachment part 614B that is not inserted through the first hole part 6141. Thus, the ring-shaped part 65 is formed. Between two portions of the base part 64 located in the −Z direction and having the insertion hole 621 formed therein, one portion is the ring-shaped part 65B and the other portion is the ring-shaped part 65C.

Each of the ring-shaped parts 65B and 65C formed in this manner has a contact part 622 and connection parts 623 and 624, in the same manner as the ring-shaped parts 62B and 62C. The connection part 624 of the ring-shaped part 65B is connected to the connection part 623 of the ring-shaped part 65C via the second hole part 6142 of the attachment part 614B and the first hole part 6141 of the attachment part 614C, and the connection part 624 of the ring-shaped part 65C is connected to the connection part 623 of the ring-shaped part 65B via the second hole part 6142 of the attachment part 614C and the first hole part 6141 of the attachment part 614B.

A portion of the ring-shaped wire WM is locked by one of the hooks 643, thereby adjusting the inner diameter of each of the ring-shaped parts 65B and 65C. For example, when a portion of the wire WM is locked by the hook 643 closest to the fixing part 615, that is, the hook 643 closest to the wrist, the inner diameter of each of the ring-shaped parts 65B and 65C becomes smallest. In addition, for example, when a portion of the wire WM is locked by the hook 643 closest to the attachment part 614, that is, the hook 643 farthest from the wrist, the inner diameter of each of the ring-shaped parts 65B and 65C becomes largest.

In this way, by changing the inner diameter of each of the ring-shaped parts 65B and 65C, the pulling force applied by the connection parts 623 and 624 of each of the ring-shaped parts 65B and 65C can be adjusted. Accordingly, the target finger F can be easily inserted through each of the ring-shaped parts 65B and 65C, the base part 61 can be stably mounted on the back of the target hand HN, and the mounting member 6B can be stably mounted on the target hand HN.

### Effect of Second Embodiment

The haptic force feedback system according to the present embodiment described above has the same effects as the haptic force feedback system 1 according to the first embodiment, and also has the following effects.

In the mounting member 6B, the base part body 641 of the base part 64 has the adjustment part 642 that adjusts the inner diameter of the ring-shaped part 65.

According to the configuration, by adjusting the inner diameter of the ring-shaped part 65 using the adjustment part 642, the target finger F can be easily inserted through the ring-shaped part 65, and the ring-shaped part 65 can easily make contact with the ventral portion of the target finger F.

Therefore, the mounting member 6B can be stably mounted on a hand.

In the mounting member 6B, the adjustment part 642 has the plurality of hooks 643. The plurality of hooks 643 are provided on the base part body 641 of the base part 64 and locks the wire WM constituting the ring-shaped part 65. The plurality of hooks 643 are aligned from the ring-shaped part 65 toward the mounting part 63.

According to the configuration, by changing the hook 643 for locking the wire WM among the plurality of hooks 643, the inner diameter of the ring-shaped part 65 formed by the wire WM can be adjusted. Therefore, the ring-shaped part 65 can easily make contact with the ventral portion of the target finger, and the mounting member 6B can be stably mounted on the target hand HN.

### Third Embodiment

Next, a third embodiment of the present invention will be described.

A haptic force feedback system according to the present invention has the same configuration as the haptic force feedback system 1 according to the present embodiment, but is different from the haptic force feedback system 1 according to the present embodiment in the base part and the ring-shaped part of the mounting member. In the following description, portions that are the same or substantially the same as portions already described will be given the same reference numerals, and a description thereof will be omitted.

### Schematic Configuration of Haptic Force Feedback System and Haptic Force Feedback Device

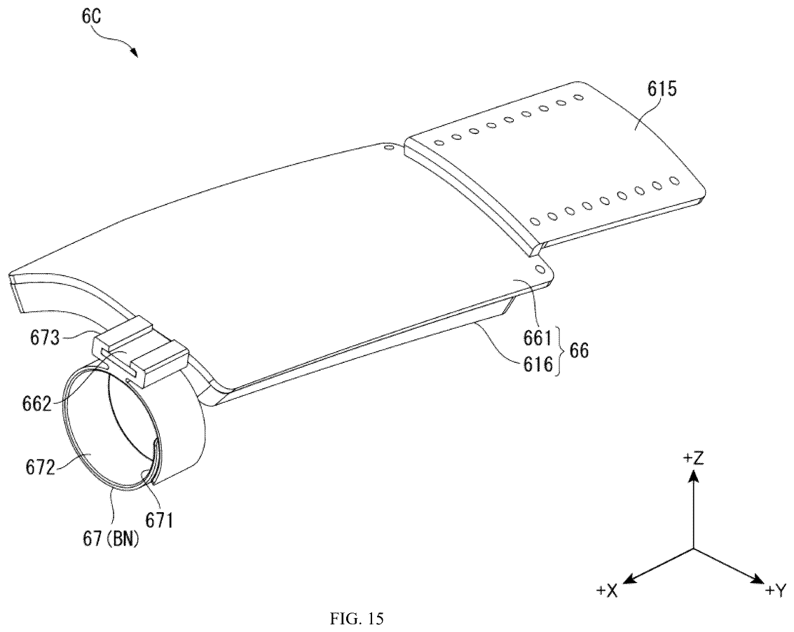

FIG. 15 is a perspective view showing a mounting member 6B of a haptic force feedback device included in a haptic force feedback system according to the present embodiment.

The haptic force feedback system according to the present embodiment has the same configuration and functions as the haptic force feedback system 1 according to the first embodiment, except that the haptic force feedback system has a mounting member 6C shown in FIG. 15 instead of the mounting member 6A. That is, the haptic force feedback device according to the present embodiment has the same configuration and functions as the haptic force feedback device 2 according to the first embodiment, except that the haptic force feedback device has the mounting member 6C instead of the mounting member 6A.

### Configuration of Mounting Member

The mounting member 6C has the same configuration and functions as the mounting member 6A according to the first embodiment, except that the mounting member 6C includes a base part 66 and a ring-shaped part 67 instead of the base part 61 and the ring-shaped part 62 according to the first embodiment. That is, the mounting member 6C includes the base part 66, the ring-shaped part 67, and a mounting part 63.

### Configuration of Base Part

The base part 66 is disposed on the back of the target hand HN in the same manner as the base part 61. The base part 66 has an adhesive sheet 617 that is not shown in FIG. 15, in addition to a base part body 661 and a cushioning material 616.

The base part body 661 is formed in a shape along the back and wrist of the target hand HN when viewed from a position facing the back of the target hand HN. The base part body 661 has the same configuration and functions as the base part body 611 according to the first embodiment, except that the base part body 661 has an attachment part 662 instead of the plurality of attachment parts 614. That is, the base part body 661 has an extension part 612 and a plurality of support parts 613 not shown in FIG. 15, in addition to a fixing part 615 and the attachment part 662.

The attachment part 662 is provided on the base part body 661. The ring-shaped part 67 is detachably attached to the attachment part 662. The attachment part 662 protrudes from an end part of the base part body 661 opposite to the fixing part 615 to a side opposite to the fixing part 615.

Specifically, the attachment part 662 protrudes in the +X direction from the end part of the base part body 661 in the +X direction.

### Configuration of Ring-Shaped Part

The ring-shaped part 67 is mounted on the base of the target finger F. In an example of FIG. 15, the ring-shaped part 67 is mounted on the index finger FB, which is the target finger F. The ring-shaped part 67 has an insertion hole 671 into which the target finger F is inserted along a central axis of the ring-shaped part 67.

The ring-shaped part 67 is attached to the attachment part 662 and is a cylindrical body that partially overlaps with each other in a radial direction of the ring-shaped part 67. That is, the ring-shaped part 67 is formed in a cylindrical shape in which a band-shaped body BN that constitutes the ring-shaped part 67 is wound more than one turn, in which one end and the other end of the band-shaped body BN are spaced apart from each other. In other words, the ring-shaped part 67 is formed in a spiral shape with one or more turns when viewed along the central axis of the ring-shaped part 67.

Therefore, the ring-shaped part 67 is configured such that the inner diameter of the insertion hole 671 can be expanded or contracted. When the target finger F is inserted into the insertion hole 671, the ring-shaped part 67 is radially expanded or contracted depending on the size of the target finger, so that the ring-shaped part 67 is fitted to the target finger F. Accordingly, the ring-shaped part 67 is stably mounted on the target finger F.

The ring-shaped part 67 has a contact part 672 and a connection part 673.

The contact part 672 makes contact with the ventral side of the target finger F inserted into the insertion hole 671.

The connection part 673 is provided corresponding to a back portion of the target finger F inserted into the insertion hole 671. That is, the connection part 673 is provided on a side of the ring-shaped part 67 opposite to the contact part 672. The connection part 673 is connected to the attachment part 662. Accordingly, the ring-shaped part 67 is attached to the base part body 661.

### Action of Mounting Member

When the mounting member 6C is mounted on the target hand HN, the ring-shaped part 67 provided on the base part 66 is mounted on the target finger F in a fitted state, and the mounting part 63 provided on a side of the base part 66 opposite to the ring-shaped part 67 is mounted on the wrist of the target hand HN.

As a result, in a state where the target finger F is not bent, a state where the base part 66 is disposed on the back of the target hand HN is maintained.

In addition, in a state where the target finger F is bent, the ring-shaped part 67 attempts to move toward the palm of the target hand HN due to the bending of the target finger F, but since the ring-shaped part 67 is attached to the base part 66, the base part 66 is pulled toward the back of the target hand HN by the ring-shaped part 67 based on the portion close to the mounting part 63, which serves as a fulcrum. Accordingly, the base part 66 presses the back of the target hand HN and is brought into close contact with the back of the target hand HN.

In this way, even if the target finger F moves, the state of the mounting member 6C mounted on the target hand HN is maintained, so that it is possible to enhance the wearing comfort of the mounting member 6C on the target hand HN and the wearing comfort of the haptic force feedback device.

In the example shown in FIG. 15, one ring-shaped part 67 is attached to the base part 66. However, the present invention is not limited thereto, and the number of ring-shaped parts 67 provided on the base part 66 can be changed as appropriate. In addition, the target finger F inserted into the ring-shaped part 67 is not limited to the index finger FB, and may be other fingers such as the thumb FA and the middle finger FC.

### Effect of Third Embodiment

The haptic force feedback system according to the present embodiment described above has the same effects as the haptic force feedback system 1 according to the first embodiment, and also has the following effects.

In the mounting member 6C, the ring-shaped part 67 is the cylindrical body defining the insertion hole 671 into which the target finger F is inserted. The ring-shaped part 67 is configured such that the insertion hole 671 can be radially expanded or contracted.

According to the configuration, the inner diameter of the insertion hole 671 is expanded, so that it is possible to easily insert the target finger F into the insertion hole 671, and the inner diameter of the insertion hole 671 is reduced, so that it is possible to bring the ring-shaped part 67 into close contact with the target finger F. In this way, as the inner diameter of the insertion hole 671 into which the target finger F is inserted is reduced, the base part 66 provided with the ring-shaped part 67 is pulled in a direction approaching the back of the target hand HN. That is, since the ring-shaped part 67 applies the pulling force to the base part 66, it is possible to easily bring the base part 66 into close contact with the back of the target hand HN. Therefore, the mounting member 6C can be mounted on the target hand HN more stably.

In the mounting member 6C, the base part 66 has the attachment part 662 to which the ring-shaped part 67 is detachably attached.

According to the configuration, the ring-shaped part 67 can be replaced. Therefore, the ring-shaped part 67 adapted to the thickness of the target finger F can be attached to the base part 66.

Accordingly, it is possible to enhance the wearing comfort of the mounting member 6C on the target hand HN.

### Fourth Embodiment

Next, a fourth embodiment of the present invention will be described.

A haptic force feedback system according to the present invention has the same configuration as the haptic force feedback system 1 according to the present embodiment, but is different from the haptic force feedback system 1 according to the present embodiment in the ring-shaped part of the mounting member. In the following description, portions that are the same or substantially the same as portions already described will be given the same reference numerals, and a description thereof will be omitted.

### Schematic Configuration of Haptic Force Feedback System and Haptic Force Feedback Device

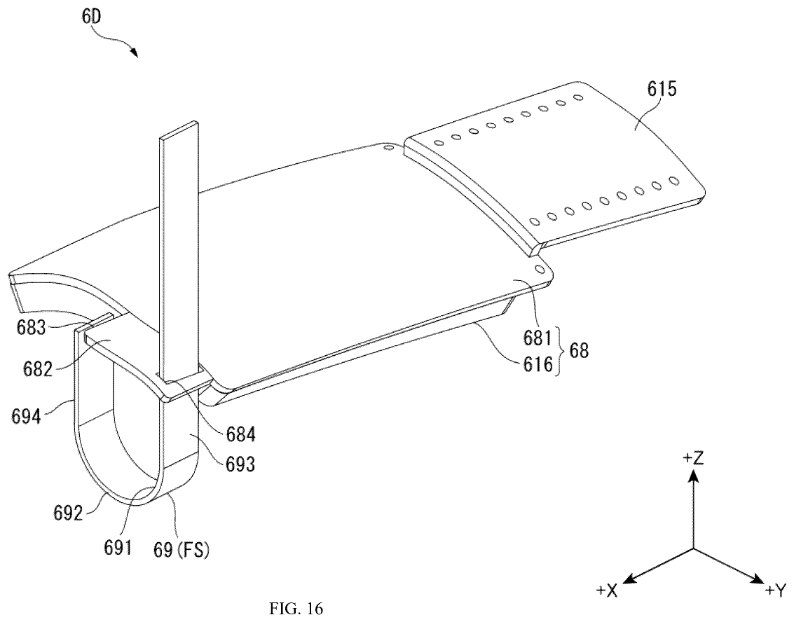

FIG. 16 is a perspective view showing a mounting member 6C of a haptic force feedback device included in a haptic force feedback system according to the present embodiment.

The haptic force feedback system according to the present embodiment has the same configuration and functions as the haptic force feedback system 1 according to the first embodiment, except that the haptic force feedback system has a mounting member 6D shown in FIG. 16 instead of the mounting member 6A. That is, the haptic force feedback device according to the present embodiment has the same configuration and functions as the haptic force feedback device 2 according to the first embodiment, except that the haptic force feedback device has the mounting member 6D instead of the mounting member 6A.

### Configuration of Mounting Member

The mounting member 6D has the same configuration and functions as the mounting member 6A according to the first embodiment, except that the mounting member 6D includes a base part 68 and a ring-shaped part 69 instead of the base part 61 and the ring-shaped part 62. That is, the mounting member 6D includes the base part 68, the ring-shaped part 69, and a mounting part 63.

### Configuration of Base Part

The base part 68 is disposed on the back of the target hand HN in the same manner as the base part 61 according to the first embodiment. The base part 68 has a base part body 681, a cushioning material 616, and an adhesive sheet 617.

The base part body 681 is formed in a shape along the back and wrist of the target hand HN when viewed from a position facing the back of the target hand HN. The base part body 681 has the same configuration and functions as the base part body 611 according to the first embodiment, except that the base part body 681 has an attachment part 682 instead of the plurality of attachment parts 614. That is, the base part body 681 has an extension part 612 and a plurality of support parts 613 not shown in FIG. 16, in addition to a fixing part 615 and the attachment part 682.

The attachment part 682 protrudes from an end part of the base part body 681 opposite to the fixing part 615 to a side opposite to the fixing part 615. That is, the attachment part 682 protrudes in an extending direction of the target finger F from the end part of the base part body 681 close to the target finger F.

The ring-shaped part 69 is attached to the attachment part 682. More specifically, the attachment part 682 has a locking part 683 that locks one end of a hook-and-loop fastener FS constituting the ring-shaped part 69, and an insertion opening 684 through which the other end of the hook-and-loop fastener FS is inserted in the +Z direction.

In the example of FIG. 16, the attachment part 682 is provided on the base part body 681 at a position corresponding to the base of the index finger FB. That is, in the example of FIG. 16, one attachment part 682 is provided on the base part body 681. However, the present invention is not limited thereto, and for example, the attachment part 682 may be provided on the base part body 681 in accordance with the bases of other fingers such as the thumb FA and middle finger FC, or a plurality of attachment parts may be provided on the base part body 681.

### Configuration of Ring-Shaped Part

The ring-shaped part 69 includes a hook-and-loop fastener FS attached to the attachment part 682 and is mounted on the base of the target finger F. In the example of FIG. 16, the ring-shaped part 69 is mounted on the base of the index finger FB.

The ring-shaped part 69 is formed in a ring shape by providing on one end thereof with a hook-and-loop fastener FS, which is locked to the locking part 683, along the target finger F, and then attaching the other end thereof, which is inserted through the insertion opening 684, to an outer surface of the hook-and-loop fastener FS along the target finger F. In this way, the hook-and-loop fastener FS is arranged to encircle the target finger F, so that the ring-shaped part 69 is mounted on the target finger F.

In the ring-shaped part 69, a hole part through which the target finger F is inserted along the X-axis is an insertion hole 691, and a portion in contact with the ventral portion of the target finger F is a contact part 692. That is, the ring-shaped part 69 has the insertion hole 691 and the contact part 692.

In the ring-shaped part 69, a range from one end of the contact part 692 to the portion that is attached to the outer surface of the hook-and-loop fastener FS via the insertion opening 684 is a connection part 693, and a range from the other end of the contact part 692 to the portion that is locked by part 683 is a connection part 694. The connection parts 693 and 694 connect the contact part 692 to the base part 68.

### Action of Mounting Member

When the mounting member 6D is mounted on the target hand HN, the hook-and-loop fastener FS provided on the base part 68 is arranged to encircle the target finger F, so that the ring-shaped part 69 is mounted while being fitted to the target finger F. In addition, the mounting part 63, which is provided on a side the base part 68 opposite to the ring-shaped part 69, is mounted on the wrist of the target hand HN.

As a result, in a state where the target finger F is not bent, a state where the base part 68 is disposed on the back of the target hand HN is maintained.

In addition, in a state where the target finger F is bent, the ring-shaped part 69 follows the bending of the target finger F. Therefore, the end part of the base part 68 close to the ring-shaped part 69 is pulled toward the back of the target hand HN by the ring-shaped part 69. Accordingly, the base part 68 is brought into close contact with the back of the target hand HN.

In this way, the mounting member 6D maintains a state of being mounted on the target hand HN even if the target finger F moves, so that it is possible to enhance the wearing comfort of the mounting member 6D on the target hand HN and the wearing comfort of the haptic force feedback device.

### Effect of Fourth Embodiment

The haptic force feedback system according to the present embodiment described above has the same effects as the haptic force feedback system 1 according to the first embodiment, and also has the following effects.

In the mounting member 6D, the ring-shaped part 69 includes the hook-and-loop fastener FS disposed along the target finger.

According to the configuration, the inner diameter of the ring-shaped part 69 can be easily adjusted. That is, by disposing the hook-and-loop fastener FS along the target finger F, the inner diameter of the ring-shaped part 69 can be adjusted to the thickness of the target finger F, and the ring-shaped part 69 can be mounted on the target finger F. Accordingly, it is possible to enhance the wearing comfort of the mounting member 6C on the target hand HN.

### Modification of Embodiment

The present invention is not limited to the above-described embodiments, and modifications and improvements within the scope of achieving the object of the present invention are included in the present invention.

In the above-described embodiments, the ring-shaped parts 62, 65, 67, and 69 are mounted on the index finger FB serving as the target finger F. However, as described above, the ring-shaped parts 62, 65, 67, and 69 may be mounted on fingers other than the index finger FB.

The index finger FB or the middle finger FC is located substantially in the center of the target hand HN when viewed from a position facing the back of the target hand HN. Therefore, by mounting the ring-shaped parts 62, 65, 67, and 69 to at least one of the index finger FB and the middle finger FC, the base parts 61, 64, 66, and 68 and the mounting members 6A, 6B, 6C, and 6D can be stably attached to the target hand HN together with the mounting part 63.

In the second embodiment, the adjustment part 642 that adjusts the inner diameter of the ring-shaped parts 65B and 65C is provided on the base part 64. However, the present invention is not limited thereto, and since the inner diameter of the ring-shaped parts 65B and 65C can be adjusted by adjusting the length of the wire WM, the adjustment part may be provided on the ring-shaped part. The same applies to the wire WM that constitutes the ring-shaped parts 62B and 62C, and the adjustment part may be provided on each of the ring-shaped parts 62B and 62C.

When the ring-shaped parts 67 and 69 are attached to the target finger F, the inner diameter of the ring-shaped parts 67 and 69 is adjusted according to the thickness of the target finger F, so that the ring-shaped parts 67 and 69 may have the adjustment part.

In the above-described embodiments, the mounting part 63 has the band 631 that is wound around the wrist of the target hand HN, and the tightening mechanism 632 that tightens the band 631. However, the present invention is not limited thereto, and the mounting part 63 may include only a band that can be wound around the wrist of the user and is made of a material that can maintain the wound state. That is, the mounting part 63 may not include the tightening mechanism 632. An example of the band 631 may include a band including a hook-and-loop fastener.

In the above-described embodiments, the base parts 61, 64, 66, and 68 have the cushioning material 616 disposed between the base part bodies 611, 641, 661, and 681 and the back of the target hand HN. However, the present invention is not limited thereto, and the cushioning material 616 may be omitted. In this case, the base part bodies 611, 641, 661, and 681 may be provided with the adhesive sheet.

In addition, the base parts 61, 64, 66, and 68 may not be provided with the adhesive sheet 617 regardless of the presence or absence of the cushioning material 616. In addition, even when the adhesive sheet 617 is provided, the position and number of adhesive sheets 617 can be changed as appropriate.

In the above-described embodiments, the mounting members 6A, 6B, 6C, and 6D support the bending restriction part 5. However, the present invention is not limited thereto, and the mounting members 6A, 6B, 6C, and 6D may support a member having another function instead of or in addition to the bending restriction part 5. For example, the mounting members 6A, 6B, 6C, and 6D may support a device that provides another haptic force feedback to the target hand HN. In addition, for example, the mounting members 6A, 6B, 6C, and 6D may support a device that is used to detect the motion of the target hand HN, such as the magnetic sensor 112. That is, the devices and members supported by the mounting members 6A, 6B, 6C, and 6D are not limited to those described above.

### Summary of Present Invention

Hereinafter, the present invention will be summarized.

[1] A mounting member used in a haptic force feedback device that provides haptic force feedback to a hand, and mounted on the hand, the mounting member comprising:
a base part disposed in contact with a back of the hand;
a mounting part provided on one end portion of the base part and mounted on a wrist of the hand; and
a ring-shaped part provided on the other end portion of the base part, into which a target finger among fingers of the hand is inserted,
wherein the ring-shaped part is disposed at a base of the target finger inserted into the ring-shaped part to make contact with a ventral portion of the target finger.

According to the configuration, in a state where the base part is disposed in contact with the back of a hand, the mounting part provided on the base part is mounted on the wrist, and the target finger is inserted into the ring-shaped part provided on the base part. In this case, the ring-shaped part makes contact with the ventral portion at the base of the target finger. Accordingly, the ring-shaped part follows the bending motion of the target finger, and the base part provided with the ring-shaped part is pulled in the direction of bringing the base part into close contact with the back of the hand, so that the base part can be brought into close contact with the back of the hand.

Therefore, the base part can be prevented from being lifted away from the back of the hand, and so that the mounting member can be stably mounted on the hand.

[2] The mounting member according to [1],
wherein the ring-shaped part applies a pulling force to the base part toward the back of the hand.

According to the configuration, the pulling force is applied to the base part, so that it is possible to easily bring the base part into close contact with the back of the hand. Therefore, the mounting member can be mounted on the hand more stably.

[3] The mounting member according to [2],
wherein the ring-shaped part is formed by a stretchable wire provided on the base part in a ring shape.

According to the configuration, when the ring-shaped part is disposed at the base of the inserted target finger, the base part provided with the ring-shaped part is pulled by the wire constituting the ring-shaped part in a direction approaching the back of a hand based on the ventral portion at the base of the target finger. That is, since the wire constituting the ring-shaped part applies the pulling force to the base part, it is possible to easily bring the base part into close contact with the back of the hand. Therefore, the mounting member can be mounted on the hand more stably.

[4] The mounting member according to [3],
wherein the base part has:
   a first hole part into which one end portion of the wire material is inserted; and
   a second hole part into which the other end portion of the wire is inserted, and
the first hole part and the second hole part are provided in a portion of the base part opposite to the mounting part.

According to the configuration, the wire constituting the ring-shaped part can be disposed at a position of the base part corresponding to the base of the target finger. Therefore, the pulling force can be easily applied to the base part, and the mounting member can be mounted on the hand more stably.

[5] The mounting member according to [4],
wherein one of the base part and the ring-shaped part has an adjustment part configured to adjust an inner diameter of the ring-shaped part.

According to the configuration, by adjusting the inner diameter of the ring-shaped part, the finger can be easily inserted through the ring-shaped part, and the ring-shaped part can easily make contact with the ventral portion of the target finger. Therefore, the mounting member can be stably mounted on a hand.

[6] The mounting member according to [5],
wherein the adjustment part has a plurality of hooks provided on the base part and configured to lock the wire, and
the plurality of hooks are aligned from the ring-shaped part toward the mounting part.

According to the configuration, by changing the hook for locking the wire among the plurality of hooks, the inner diameter of the ring-shaped part formed by the wire can be adjusted. Therefore, the ring-shaped part can easily make contact with the ventral portion of the target finger, and the mounting member can be stably mounted on the hand.

[7] The mounting member according to [2],
wherein the ring-shaped part is a cylindrical body defining an insertion hole into which a finger of the hand is inserted, and
the cylindrical body is configured such that the insertion hole is radially expandable and contractable.

According to the configuration, the inner diameter of the insertion hole is expanded, so that it is possible to easily insert the target finger into the insertion hole, and the inner diameter of the insertion hole is reduced, so that it is possible to bring the ring-shaped part into close contact with the target finger. In this way, as the inner diameter of the insertion hole into which the target finger is inserted is reduced, the base part provided with the ring-shaped part is pulled in a direction approaching the back of the hand. That is, since the cylindrical body applies the pulling force to the base part, it is possible to easily bring the base part into close contact with the back of the hand.

Therefore, the mounting member can be mounted on the hand more stably.

[8] The mounting member according to [7],
wherein the base part has an attachment part to which the ring-shaped part is detachably attached.

According to the configuration, the ring-shaped part can be replaced. Therefore, the ring-shaped part adapted to the thickness of the target finger can be attached to the base part. Accordingly, it is possible to enhance the wearing comfort of the mounting member on the hand.

[9] The mounting member according to [2],
wherein the ring-shaped part comprises a hook-and-loop fastener arranged to encircle the finger.

According to the configuration, the inner diameter of the ring-shaped part can be easily adjusted.

That is, by arranging the hook-and-loop fastener to encircle the target finger, the inner diameter of the ring-shaped part can be adjusted to the outer diameter of the target finger, and the ring-shaped part can be mounted on the target finger. Accordingly, it is possible to enhance the wearing comfort of the mounting member on the hand.

[10] The mounting member according to any one of [1] to [9],
wherein the mounting part has:
   a band configured to be wound around the wrist; and
   a tightening mechanism configured to tighten the band around the wrist.

According to the configuration, the tightening mechanism can adjust tightness of the band around the wrist. Therefore, the wearing comfort of the mounting member on the hand can be enhanced, and the mounting member can be mounted on the hand more stably.

[11] The mounting member according to any one of [1] to [10],
wherein the base part has:
   a base part body; and
   a cushioning material having elasticity and provided between the base part body and the back of the hand so as to make contact with the back of the hand.

According to the configuration, the cushioning material is elastically deformed, thereby allowing the base part body to be stably mounted on the back of the hand.

[12] The mounting member according to [11],
wherein the base part has an adhesive sheet provided on a contact surface of the cushioning material for contacting the back of the hand.

According to the configuration, the adhesive sheet provided on the cushioning material makes contact with the back of the hand, so that it is possible to prevent the displacement of the cushioning material and the base part body relative to the back of the hand. Therefore, the base part can be stably mounted on the back of the hand, and the mounting member can be stably mounted on the hand.

[13] A haptic force feedback device comprising:
the mounting member according to any one of [1] to [12];
a pressing part configured to press a ventrum of a first finger of the hand;
a vibration generation part configured to apply vibration to the first finger; and
a bending restriction part extending from the base part along the first finger and configured to restrict bending of the first finger.

According to the configuration, the mounting member is stably mounted on the hand, so that the pressing part can effectively press the first finger. In addition, the vibration generated by the vibration generation part can be effectively transmitted to the first finger, and the bending restriction part can effectively restrict the bending of the first finger. Accordingly, for example, the user can be given the sensation of gripping an object.

### Reference Signs List

1 . . . haptic force feedback system, 2 . . . haptic force feedback device, 3 . . . pressing part, 4 . . . vibration generation part, 5 . . . bending restriction part, 6A, 6B, 6C, and 6D . . . mounting member, 61, 64, 66, and 68 . . . base part, 611, 641, 661, and 681 . . . base part body, 612 . . . extension part, 613 . . . support part, 614, 614B, 614C, 662, and 682 . . . attachment part, 6141 . . . first hole part, 6142 . . . second hole part, 615 . . . fixing part, 616 . . . cushioning material, 617 . . . adhesive sheet, 642. . . adjustment part, 643 . . . hook, 62, 62B, 62C, 65, 65B, 65C, 67, and 69 . . . ring-shaped part, 622. . . contact part, 623 and 624 . . . connection part, 63 . . . mounting part, 631 . . . band, 632 . . . tightening mechanism, 7 . . . control part.

1. A mounting member used in a haptic force feedback device that provides haptic force feedback to a hand, and mounted on the hand, the mounting member comprising:
a base part disposed in contact with a back of the hand;
a mounting part provided on one end portion of the base part and mounted on a wrist of the hand; and
a ring-shaped part provided on the other end portion of the base part, into which a target finger among fingers of the hand is inserted, wherein the ring-shaped part is disposed at a base of the target finger inserted into the ring-shaped part to make contact with a ventral portion of the target finger.

2. The mounting member according to claim 1, wherein the ring-shaped part applies a pulling force to the base part toward the back of the hand.

3. The mounting member according to claim 2, wherein the ring-shaped part is formed by a stretchable wire provided on the base part in a ring shape.

4. The mounting member according to claim 3,
wherein the base part has:
a first hole part into which one end portion of the stretchable wire is inserted; and
a second hole part into which the other end portion of the stretchable wire is inserted, and
the first hole part and the second hole part are provided in a portion of the base part opposite to the mounting part.

5. The mounting member according to claim 4,
wherein one of the base part and the ring-shaped part has an adjustment part configured to adjust an inner diameter of the ring-shaped part.

6. The mounting member according to claim 5,
wherein the adjustment part has a plurality of hooks provided on the base part and configured to lock the stretchable wire, and
the plurality of hooks are aligned from the ring-shaped part toward the mounting part.

7. The mounting member according to claim 2,
wherein the ring-shaped part is a cylindrical body defining an insertion hole into which a finger of the hand is inserted, and
the cylindrical body is configured such that the insertion hole is radially expandable and contractable.

8. The mounting member according to claim 7,
wherein the base part has an attachment part to which the ring-shaped part is detachably attached.

9. The mounting member according to claim 2,
wherein the ring-shaped part comprises a hook-and-loop fastener arranged to encircle the target finger.

10. The mounting member according to claim 1,
wherein the mounting part has:
a band configured to be wound around the wrist; and
a tightening mechanism that tightens the band around the wrist.

11. The mounting member according to claim 1,
wherein the base part has:
a base part body; and
a cushioning material that has elasticity and is provided between the base part body and the back of the hand to make contact with the back of the hand.

12. The mounting member according to claim 11,
wherein the base part has an adhesive sheet provided on a contact surface of the cushioning material for contacting the back of the hand.

13. A haptic force feedback device comprising:
a mounting member used in a haptic force feedback device that provides haptic force feedback to a hand, and mounted on the hand;
a pressing part configured to press a ventrum of a first finger of the hand;
a vibration generation part configured to generate vibration to the first finger; and
a bending restriction part configured to extend from a base part and along the first finger and configured to restrict bending of the first finger, wherein the mounting member comprises:
a base part disposed in contact with a back of the hand;
a mounting part provided on one end portion of the base part and mounted on a wrist of the hand; and
a ring-shaped part provided on the other end portion of the base part, into which a target finger among fingers of the hand is inserted,
wherein the ring-shaped part is disposed at a base of the target finger inserted into the ring-shaped part to make contact with a ventral portion of the target finger.

14. The haptic force feedback device according to claim 13,
wherein the ring-shaped part applies a pulling force to the base part toward the back of the hand.

15. The haptic force feedback device according to claim 14,
wherein the ring-shaped part is formed by a stretchable wire provided on the base part in a ring shape.

16. The haptic force feedback device according to claim 15,
wherein the base part has:
a first hole part into which one end portion of the stretchable wire is inserted; and
a second hole part into which the other end portion of the stretchable wire is inserted, and
the first hole part and the second hole part are provided in a portion of the base part opposite to the mounting part.

17. The haptic force feedback device according to claim 16,
wherein one of the base part and the ring-shaped part has an adjustment part configured to adjust an inner diameter of the ring-shaped part.

18. The haptic force feedback device according to claim 17,
wherein the adjustment part has a plurality of hooks provided on the base part and configured to lock the stretchable wire, and
the plurality of hooks are aligned from the ring-shaped part toward the mounting part.

19. The haptic force feedback device according to claim 18,
wherein the ring-shaped part is a cylindrical body defining an insertion hole into which a finger of the hand is inserted,
wherein the cylindrical body is configured such that the insertion hole is radially expandable and contractable, and
wherein the base part has an attachment part to which the ring-shaped part is detachably attached.

20. The haptic force feedback device according to claim 14,
wherein the ring-shaped part comprises a hook-and-loop fastener arranged to encircle the target finger.
